(19) United States
(12) Patent Application Publication
(10) Pub. No.: US 2009/0189119 A1
(43) Pub. Date: Jul. 30, 2009

(54) Use of metal complex compounds comprising pyridine pyrimidine or s-triazine derived ligands as catalysts for oxidations with organic peroxy acids and/or precursors of organic peroxy acids and h202

(76) Inventors: Torsten Wieprecht, Schopfheim (DE); Uwe Heinz, Saarlouis (DE); Juntao Xia, Shanghai (CN); Gunther Schlingloff, Riehen (CH); Marie-Josee Dubs, Wittersdorf (FR)

Correspondence Address: JoAnn Villamizar;Ciba Corporation/Patent Department, 540 White Plains Road, P.O. Box 2005, Tarrytown, NY, 10591, US

(21) Appl. No.: 10/585,543

(22) PCT Filed: Jan. 3, 2005
(86) PCT No.: PCT/EP05/50000

§ 371 Date: Jul. 10, 2006

(30) Foreign Application Priority Data
Jan. 12, 2004 (EP) 04100078.7

(51) Int. Cl. C11D 3/395

(52) U.S. Cl. 252/186.39

(57) ABSTRACT

The invention accordingly relates to the use as catalysts of at least one metal complex of formula (1) [LₙMeₘXₚ]^{z}Y_{q} (1), wherein all substituents have the meanings as defined in the claims for oxidation reactions with organic peroxy acids and/or precursors of organic peroxy acid and H₂O₂, as well as to novel detergent compositions.

The present invention relates to the use of specific metal complex compounds as oxidation catalysts with organic peroxy acids and/or precursors of organic peroxy acids and with H₂O₂ and/or precursors of H₂O₂ as oxidants. The present invention relates also to formulations comprising such metal complex compounds and organic peroxy acids and/or precursors of organic peroxy acids.

The metal complex compounds are used especially for improving the action of peroxy acids, for example in the treatment of textile material, without at the same time causing any appreciable damage to fibres and dyeings.

Traditionally, peroxide-containing bleaching agents have been used in washing and cleaning processes. They have an excellent action at a liquor temperature of 90° C. and above, but their performance noticeably decreases with lower temperatures. Currently, peroxy acid precursors are used to activate peroxide-containing bleaching agents. Tetraacetyl ethylenediamine (TAED) is mainly used as the activator in European washing systems. US systems, on the other hand, are frequently based on sodium nonanoylbenzosulfonate (Na-NOBS). Activator systems are effective in general, but the bleaching action of currently customary activators is inadequate under certain but desirable washing conditions (e.g. low temperature, short wash cycle).

It is known that, in addition to bleach activators, some transition metal complexes are capable of activating hydrogen peroxide and thus accelerating bleaching processes.

In respect of H₂O₂ activation having effective bleaching action, mononuclear and polynuclear variants of manganese complexes with various ligands, especially 1,4,7-trimethyl-1,4,7-triazacyclononane and optionally oxygen-containing bridge ligands, are currently regarded as being especially effective. Such catalysts have adequate stability under practical conditions and, with Mnⁿ⁺, contain an ecologically acceptable metal cation, but their use is unfortunately associated with considerable damage to dyes and fibres.

In the present invention, it has now, surprisingly, been found that specific metal complexes are capable of acting as catalysts in oxidation processes that use peroxy acids and/or peroxyacid precursors in various fields of use. The advantage of those compounds is that they can considerably enhance the bleach performance of present bleach systems that consist of peroxy acid or precursors of peroxy acid and H₂O₂ and/or precursors of H₂O₂. Furthermore, because of their catalytic action, the performance increase can be obtained with only small amounts of catalyst.

The invention accordingly relates to the use as catalysts of at least one metal complex of formula (1)

[LₙMeₘXₚ]^{z}Y_{q} (1),

wherein

Me is manganese; titanium; iron, cobalt; nickel or copper,

X is a coordinating or bridging radical,

n and m are each independently of the other an integer having a value of from 1 to 8,

p is an integer having a value of from 0 to 32,

z is the charge of the metal complex,

Y is a counter-ion,

q=z/(charge of Y), and

L is a ligand of formula (2)

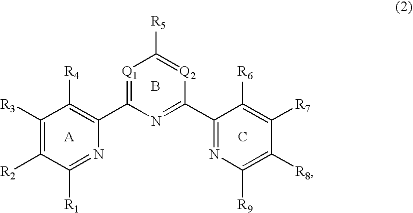

wherein

Q₁ is N or CR₁₀,

Q₂ is N or CR₁₁,

R₁, R₂, R₃, R₄, R₅, R₆, R₇, R₅, R₉, R₁₀ and R₁₁ are each independently of the others hydrogen;

unsubstituted or substituted C₁-C₁₈alkyl or unsubstituted or substituted aryl; cyano; halogen; nitro; —COOR₁₂ or —SO₃R₁₂ wherein
R₁₂ is in each case hydrogen, a cation or unsubstituted or substituted C₁-C₁₈alkyl or
unsubstituted or substituted aryl;

—SR₁₃; —SO₂R₁₃ or —OR₁₃ wherein
R₁₃ is in each case hydrogen or unsubstituted or substituted C₁-C₁₈alkyl or
unsubstituted or substituted aryl;

—NR₁₄R₁₅; —(C₁-C₆alkylene)-NR₁₄R₁₅; —N^{⊕}R₁₄R₁₅R₁₆; —C₁-C₆alkylene)-N^{⊕}R₁₄R₁₅R₁₆;

—N(R₁₃)—(C₁-C₆alkylene)-NR₁₄R₁₅; —N[(C₁-C₆alkylene)-N^{⊕}R₁₄R₁₅]₂;

—N(R₁₃)—(C₁-C₆alkylene)-N^{⊕}R₁₄R₁₅R₁₆; —N[(C₁-C₆alkylene)-N^{⊕}R₁₄R₁₅R₁₆]₂; —N(R₁₃)—N—R₁₄R₁₅ or —N(R₁₃)—N^{⊕}R₁₄R₁₅R₁₈, wherein
R₁₃ is as defined above and
R₁₄, R₁₅ and R₁₆ are each independently of the other(s) hydrogen or unsubstituted or
substituted C₁-C₁₈alkyl or unsubstituted or substituted aryl, or
R₁₄ and R₁₅, together with the nitrogen atom linking them, form an unsubstituted or
substituted 5-, 6- or 7-membered ring which may contain further hetero atoms, for oxidation reactions with organic peroxy acids and/or precursors of organic peroxy acid and with H₂O₂ and/or precursors of H₂O₂.

Suitable substituents for the alkyl groups, aryl groups, alkylene groups or 5-, 6- or 7-membered rings are especially C₁-C₄alkyl; C₁-C₄alkoxy; hydroxy; sulfo; sulfato; halogen; cyano; nitro; carboxy; amino; N-mono- or N,N-di-C₁-C₄alkylamino unsubstituted or substituted by hydroxy in the alkyl moiety; N-phenylamino; N-naphthylamino; phenyl; phenoxy or naphthyloxy.

Generally, halogen is preferably chlorine, bromine or fluorine, with special preference being given to chlorine.

Suitable metal ions for Me are e.g. manganese in oxidation states II-V, titanium in oxidation states III and IV, iron in oxidation states I to IV, cobalt in oxidation states I to III, nickel in oxidation states I to III and copper in oxidation states I to III, with special preference being given to manganese, especially manganese in oxidation states II to IV, preferably in oxidation state II. Also of interest are titanium IV, iron IIV, cobalt II-III, nickel II-III and copper II-III, especially iron II-IV.

For the radical X there come into consideration, for example, CH₃CN, H₂O, F, Cl⁻, Br⁻, HOO⁻, O₂²⁻, O²⁻, R₁₇COO⁻, R₁₇O⁻, LMeO⁻ and LMeOO⁻, wherein R₁₇ is hydrogen or unsubstituted or substituted C₁-C₁₈alkyl or aryl, and C₁-C₁₈alkyl, aryl, L and Me have the definitions and preferred meanings given hereinabove and herein below. R₁₇ is especially preferably hydrogen, C₁-C₄alkyl or phenyl, especially hydrogen.

As counter-ion Y there come into consideration, for example, R₁₇COO⁻, ClO₄⁻, BF₄⁻; PF₆⁻, R₁₇SO₃⁻, R₁₇SO₄⁻, SO₄²⁻, NO₃⁻, F⁻, Cl⁻, Br⁻ and I⁻, wherein R₁₇ is hydrogen or unsubstituted or substituted C₁-C₁₈alkyl or aryl. R₁₇ as C₁-C₁₈alkyl or aryl has the definitions and preferred meanings given hereinabove and herein below. R₁₇ is especially preferably hydrogen, C₁-C₄alkyl or phenyl, especially hydrogen. The charge of the counter-ion Y is accordingly preferably 1- or 2-, especially 1-.

n is preferably an integer having a value of from 1 to 4, preferably 1 or 2 and especially 1.

m is preferably an integer having a value of 1 or 2, especially 1.

p is preferably an integer having a value of from 0 to 4, especially 2.

z is preferably an integer having a value of from 8− to 8+, especially from 4− to 4+ and especially preferably from 0 to 4+. z is more especially the number 0.

q is preferably an integer from 0 to 8, especially from 0 to 4 and is especially preferably the number 0.

The C₁-C₁₈alkyl radicals mentioned are generally, for example, straight-chain or branched alkyl radicals, such as methyl, ethyl, n-propyl, isopropyl, n-butyl, sec-butyl, isobutyl, tert-butyl or straight-chain or branched pentyl, hexyl, heptyl or octyl. Preference is given to C₁-C₁₂alkyl radicals, especially C₁-C₈alkyl radicals and preferably C₁-C₄alkyl radicals. The mentioned alkyl radicals may be unsubstituted or substituted e.g. by hydroxy, C₁-C₄alkoxy, sulfo or by sulfato, especially by hydroxy. The corresponding unsubstituted alkyl radicals are preferred. Very special preference is given to methyl and ethyl, especially methyl.

Examples of aryl radicals that generally come into consideration are phenyl or naphthyl each unsubstituted or substituted by C₁-C₄alkyl, C₁-C₄alkoxy, halogen, cyano, nitro, carboxy, sulfo, hydroxy, amino, N-mono- or N,N-di-C₁-C₄alkylamino unsubstituted or substituted by hydroxy in the alkyl moiety, N-phenylamino, N-naphthylamino, phenyl, phenoxy or by naphthyloxy. Preferred substituents are C₁-C₄alkyl, C₁-C₄alkoxy, phenyl and hydroxy. Special preference is given to the corresponding phenyl radicals.

The C₁-C₆alkylene groups mentioned are, for example, straight-chain or branched alkylene radicals, such as methylene, ethylene, n-propylene or n-butylene. C₁-C₄alkylene groups are preferred. The alkylene radicals mentioned may be unsubstituted or substituted, for example by hydroxy or C₁-C₄alkoxy.

Examples of cations that generally come into consideration are alkali metal cations, such as lithium, potassium and especially sodium, alkaline earth metal cations, such as magnesium and calcium, and ammonium cations. The alkali metal cations, especially sodium, are preferred.

R₁₂ is preferably hydrogen, a cation, C₁-C₁₂alkyl, unsubstituted phenyl or phenyl substituted as indicated above. R₁₂ is especially preferably hydrogen, an alkali metal cation, alkaline earth metal cation or ammonium cation, C₁-C₄alkyl or phenyl, more especially hydrogen or an alkali metal cation, alkaline earth metal cation or ammonium cation.

R₁₃ is preferably hydrogen, C₁-C₁₂alkyl, unsubstituted phenyl or phenyl substituted as indicated above. R₁₃ is especially preferably hydrogen, C₁-C₄alkyl or phenyl, more especially hydrogen or C₁-C₄alkyl, preferably hydrogen.

Examples of the radical of formula —N(R₁₃)—NR₁₄R₁₅ that may be mentioned are —N(CH₃)—NH₂ and, especially, —NH—NH₂. Examples of the radical of formula —OR₁₃ that may be mentioned are hydroxy and C₁-C₄alkoxy, such as methoxy and especially ethoxy. When R₁₄ and R₁₅, together with the nitrogen atom linking them, form a 5-, 6- or 7-membered ring, that ring is preferably an unsubstituted or C₁-C₄alkyl-substituted pyrrolidine, piperidine, piperazine, morpholine or azepane ring, wherein the amino groups may be quaternised, in which case preferably the nitrogen atoms that are not bonded directly to one of the three rings A, B and/or C are quaternised.

The piperazine ring may, for example, be substituted by one or two unsubstituted C₁-C₄alkyl and/or substituted C₁-C₄alkyl at the nitrogen atom not bonded to the pyridine ring. In addition, R₁₄, R₁₅ and R₁₆ are preferably hydrogen, unsubstituted or hydroxy-substituted C₁-C₁₂alkyl, unsubstituted phenyl or phenyl substituted as indicated above. Special preference is given to hydrogen, C₁-C₄alkyl or phenyl each unsubstituted or hydroxy-substituted, especially hydrogen or unsubstituted or hydroxy-substituted C₁-C₄alkyl, preferably hydrogen. Examples of the radical of formula —NR₁₄R₁₅ that may be mentioned are —NH₂, —NHCH₂CH₂OH, —N(CH₂CH₂OH)₂, —N(CH₃)CH₂CH₂OH, and the pyrrolidine, piperidine, piperazine, morpholine or azepane ring as well as 4-methyl-piperazin-1-yl.

Preference is given to ligands L of formula (2) wherein R₅ is not hydrogen.

Preference is given likewise to ligands L of formula (2) wherein R₅ is preferably C₁-C₁₂alkyl; phenyl unsubstituted or substituted by C₁-C₄alkyl, C₁-C₄alkoxy, halogen, cyano, nitro, carboxy, sulfo, hydroxy, amino, N-mono- or N,N-di-C₁-C₄alkylamino unsubstituted or substituted by hydroxy in the alkyl moiety, N-phenylamino, N-naphthylamino, phenyl, phenoxy or by naphthyloxy; cyano; halogen; nitro; —COOR₁₂ or —SO₃R₁₂ wherein R₁₂ is in each case hydrogen, a cation, C₁-C₁₂alkyl, unsubstituted phenyl or phenyl substituted as indicated above; —SR₁₃, —SO₂R₁₃ or —OR₁₃ wherein R₁₃ is in each case hydrogen, C₁-C₁₂alkyl, unsubstituted phenyl or phenyl substituted as indicated above; —N(R₁₃)—NR₁₄R₁₅ wherein R₁₃ is as defined above and R₁₄ and R₁₅ are each independently of the other hydrogen, unsubstituted or hydroxy-substituted C₁-C₁₂alkyl, unsubstituted phenyl or phenyl substituted as indicated above, or R₁₄ and R₁₅, together with the nitrogen atom linking them, form an unsubstituted or C₁-C₄alkyl-substituted pyrrolidine, piperidine, piperazine, morpholine or azepane ring; —NR₁₄R₁₅ or —N^{⊕}R₁₄R₁₅R₁₆ wherein R₁₄, R₁₅ and R₁₆ are each independently of the other(s) hydrogen, unsubstituted or hydroxy-substituted C₁-C₁₂alkyl, unsubstituted phenyl or phenyl substituted as indicated above, or R₁₄ and R₁₅, together with the nitrogen atom linking them, form an unsubstituted or C₁-C₄alkyl-substituted pyrrolidine, piperidine, piperazine, morpholine or azepane ring; N-mono- or N,N-di-C₁-C₄alkyl-N^{⊕}R₁₄R₁₅R₁₆ unsubstituted or substituted by hydroxy in the alkyl moiety, wherein R₁₄, R₁₅ and R₁₆ are each independently of the others hydrogen, unsubstituted or hydroxy-substituted C₁-C₁₂alkyl, unsubstituted phenyl or phenyl substituted as indicated above, or R₁₄ and R₁₅, together with the nitrogen atom linking them, form a pyrrolidine, piperidine, piperazine, morpholine or azepane ring which is unsubstituted or substituted by at least one C₁-C₄alkyl or by at least one unsubstituted C₁-C₄alkoxy and/or substituted C₁-C₄alkyl, wherein the nitrogen atom may be quaternised; N-mono- or N,N-di-C₁-C₄alkyl-NR₁₄R₁₅ unsubstituted or substituted by hydroxy in the alkyl moiety, wherein R₁₄ and R₁₅ may have any one of the above meanings.

R₅ in L of formula (2) is very especially C₁-C₄alkoxy; hydroxy; phenyl unsubstituted or substituted by C₁-C₄alkyl, C₁-C₄alkoxy, phenyl or by hydroxy; hydrazine; amino; N-mono- or N,N-di-C₁-C₄alkylamino unsubstituted or substituted by hydroxy in the alkyl moiety, wherein the nitrogen atoms, especially the nitrogen atoms that are not bonded to one of the three rings A, B and/or C, may be quaternised; or a pyrrolidine, piperidine, morpholine or azepane ring unsubstituted or substituted by one or two unsubstituted C₁-C₄alkyl and/or substituted C₁-C₄alkyl, wherein the nitrogen atom may be quaternised.

A likewise very especially preferred radical that may be mentioned for R₅ is

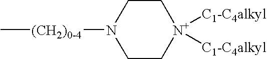

wherein the ring and the two alkyl groups may additionally be substituted.

Especially important as radicals Rr in L of formula (2) are C₁-C₄alkoxy; hydroxy; Cl; unsubstituted phenyl; phenyl substituted by C₁-C₆alkyl, OC₁-C₄alkyl, OH or phenyl; N-mono- or N,N-di-C₁-C₄alkylamino unsubstituted or substituted by hydroxy in the alkyl moiety, wherein the nitrogen atoms, especially the nitrogen atoms that are not bonded to one of the three rings A, B and/or C, may be quaternised; or a pyrrolidine, piperidine, piperazine, morpholine or azepane ring unsubstituted or substituted by at least one C₁-C₄alkyl, wherein the amino groups may be quaternised.

As examples of the radicals R₆ in of formula (2), mention may be made especially of

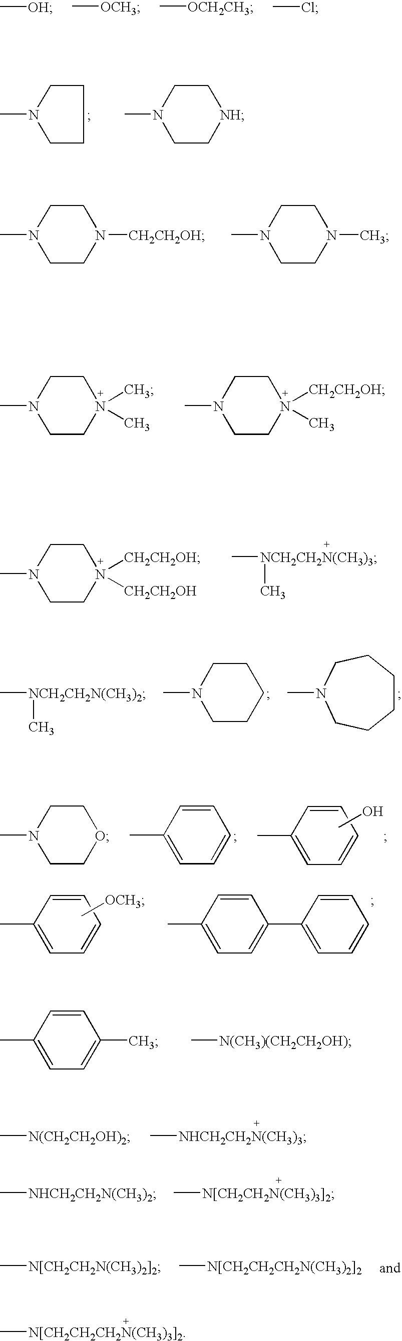

The preferred meanings indicated above for R₅ apply also to R₁, R₂, R₃, R₄, R₅, R₆, R₇, R₈, R₉, R₁₀ and R₁₁ in L, but those radicals may additionally be hydrogen.

According to one embodiment of the present invention, R₁, R₂, R₃, R₄, R₈, R₇, R₈, R₉, R₁₀ and R₁₁, in L are hydrogen and R₅ in L is a radical other than hydrogen, for which the definition and preferred meanings indicated above apply.

According to a further embodiment of the present invention, R₁, R₂, R₃, R₄, R₆, R₈, R₉, R₁₀ and R₁₁ in L are hydrogen and R₃, R₅ and R₇ in are radicals other than hydrogen, for each of which the definition and preferred meanings indicated above for R₅ apply.

Ligands L to which preference is given are those of formula (3)

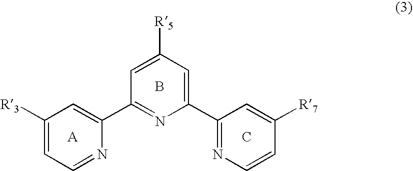

wherein R′₃ and R′₇ have the definitions and preferred meanings indicated above for R₃ and R₇ and R′₅ has the definition and preferred meanings indicated above for R₅.

Ligands L to which preference is given are those of formula (3)

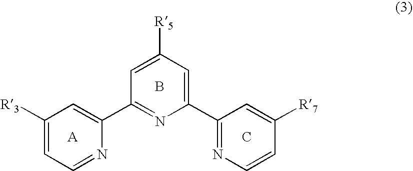

wherein R′₃ and R′₇ have the definitions and preferred meanings indicated above for R₃ and R₇ and R′₅ has the definition and preferred meanings indicated above for R₅.
and
wherein at least one nitrogen atom, which is not directly bonded to one of the rings A, B and/or C is quaternized.

Preferred as ligands L are those of formula (4) and/or (5)

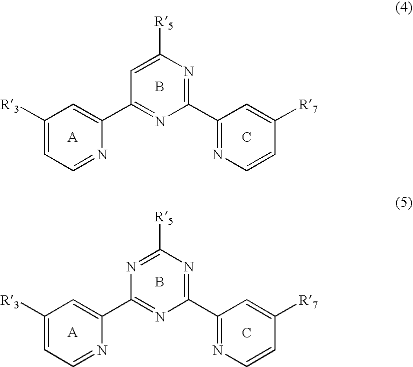

wherein R′₃ and R′₇ have the definitions and preferred meanings indicated above for R₃ and R₇, and R′₅ has the definition and preferred meanings indicated above for R₅.

Also preferred as ligands L are those of formula (4) and/or (5)

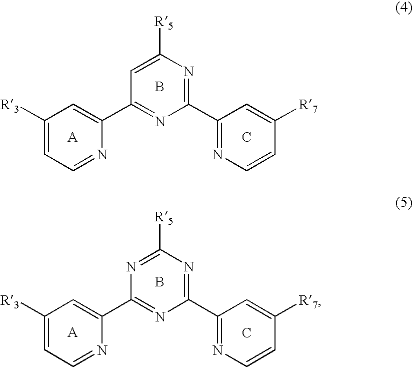

wherein R′₃ and R′₇ have the definitions and preferred meanings indicated above for R₃ and R₇, and R′₅ has the definition and preferred meanings indicated above for R₅, and wherein at least one nitrogen atom, which is not directly bonded to one of the rings A, B and/or C is quaternized.

Ligands L to which greater preference is given are those of formula (3)

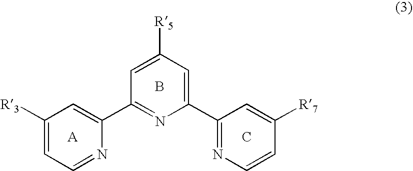

wherein R′₃, R′₅ and R′₇ are each independently of the others C₁-C₄alkoxy; hydroxy; phenyl unsubstituted or substituted by C₁-C₄alkyl, C₁-C₄alkoxy, phenyl or by hydroxy; hydrazine; amino; N-mono- or N,N-di-C₁-C₄alkylamino unsubstituted or substituted by hydroxy in the alkyl moiety; or an unsubstituted or C₁-C₄alkyl-substituted pyrrolidine, piperidine, piperazine, morpholine or azepane ring.

Ligands L to which greater preference is also given are those of formula (3)

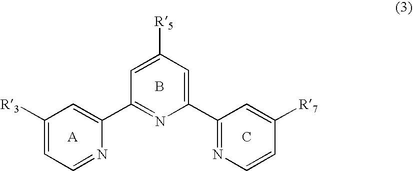

wherein R′₃, R′₅ and R′₇ are each independently of the others C₁-C₄alkoxy; hydroxy; phenyl unsubstituted or substituted by C₁-C₄alkyl, C₁-C₄alkoxy, phenyl or by hydroxy; hydrazine; amino; N-mono- or N,N-di-C₁-C₄alkylamino unsubstituted or substituted by hydroxy in the alkyl moiety; or an unsubstituted or C₁-C₄alkyl-substituted pyrrolidine, piperidine, piperazine, morpholine or azepane ring, and wherein at least one nitrogen atom, which is not directly bonded to one of the rings A, B and/or C is quaternized.

Ligands L comprising quaternized nitrogen atoms to which even greater preference is also given are those of formula (3)

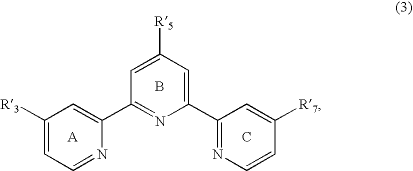

wherein R′₃ and R′₇ are independently from each other hydrogen; C₁-C₄alkoxy; hydroxy; N-mono- or N,N-di-C₁-C₄alkylamino unsubstituted or substituted by hydroxy in the alkyl moiety, wherein the nitrogen atoms, especially the nitrogen atoms that are not bonded to one of the rings A, B and/or C, may be quaternised; or a pyrrolidine, piperidine, piperazine, morpholine or azepane ring unsubstituted or substituted by at least one C₁₋₄alkyl, wherein the amino groups may be quaternised,

R′₅ is C₁-C₄alkoxy; hydroxy; N-mono- or N,N-di-C₁-C₄alkylamino unsubstituted or substituted by hydroxy in the alkyl moiety, wherein the nitrogen atoms, especially the nitrogen atoms that are not bonded to one of the rings A, B and/or C, may be quaternised; or a pyrrolidine, piperidine, piperazine, morpholine or azepane ring unsubstituted or substituted by at least one C₁-C₄alkyl, wherein the amino groups may be quaternised, with the proviso that

(i) at least one of the substituents R′₃, R′₅ and R′₇ is a radical of formula

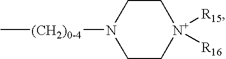

wherein R₁₅ and R₁₆ are independently from each other hydrogen or unsubstituted or substituted C₁-C₁₈alkyl or unsubstituted or substituted aryl and
wherein the unbranched or branched alkylene group may be unsubstituted or substituted, and wherein the C₁-C₄alkyl groups, which are branched or unbranched independently of one another, may be unsubstituted or substituted and wherein the piperazine ring may be unsubstituted or substituted.

Especially preferred as ligands L are those of formula (4) and/or (5)

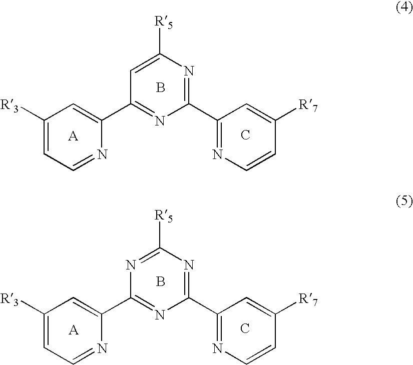

wherein
R₁₅ is C₁-C₄alkoxy; Cl; hydroxy; phenyl; phenyl substituted by OC₁-C₂alkyl, OH or C₁-C₄alkyl; N-mono- or N,N-di-C₁-C₄alkylamino unsubstituted or substituted by hydroxy in the alkyl moiety; or —NR₁₄R₁₅; —(C₁-C₆alkylene)-NR₁₄R₁₅; —N(R₁₃)—(C₁-Cralkylene)-NR₁₄R₁₅; —N[(C₁-C₆alkylene)-NR₁₄R₁₅]₂; or —N(R₁₃)N—R₁₄R₁₅, wherein
   R₁₃ is hydrogen; C₁-C₁₂alkyl or unsubstituted phenyl or phenyl substituted by (optionally substituted in the alkyl moiety by hydroxy) N-mono- or N,N-di-C₁-C₄alkylamino-, N-phenylamino-, N-naphthylamino-, phenyl-, phenoxy- or naphthyloxy, and
   R₁₄ and R₁₅ are each independently of the other hydrogen; unsubstituted or hydroxy-substituted C₁-C₁₂alkyl; unsubstituted phenyl or phenyl substituted as indicated above, or
   R₁₄ and R₁₅, together with the nitrogen atom linking them, form a pyrrolidine, piperidine, piperazine, morpholine or azepane ring that is unsubstituted or substituted by at least one unsubstituted C₁-C₄alkyl and/or substituted C₁-C₄alkyl, especially a pyrrolidine, piperidine, piperazine, morpholine or azepane ring, and
R₁₃ and R₁₇ are each independently of the other hydrogen; C₁-C₄alkoxy; Cl; hydroxy; phenyl; phenyl substituted by OC₁-C₂alkyl, OH or C₁-C₄alkyl; N-mono- or N,N-di-C₁-C₄alkylamino substituted by hydroxy in the alkyl moiety; or —NR₁₄R₁₅; —(C₁-C₆alkylene)-NR₁₄R₁₅; —N(R₁₃)—(C₁-C₆alkylene)-NR₁₄R₁₅; —N[(C₁-C₆alkylene)-NR₁₄R₁₅]₂; or —N(R₁₃)—N—R₁₄R₁₅, wherein
   R₁₃ is hydrogen; C₁-C₁₂alkyl or unsubstituted phenyl or phenyl substituted by (optionally substituted in the alkyl moiety by hydroxy) N-mono- or N,N-di-C₁-C₄alkylamino-, N-phenylamino-, N-naphthylamino-, phenyl-, phenoxy- or naphthyloxy, and
   R₁₄ and R₁₅ are each independently of the other hydrogen; unsubstituted or hydroxy-substituted C₁-C₁₂alkyl, unsubstituted phenyl or phenyl substituted as indicated above, or
   R₁₄ and R₁₅, together with the nitrogen atom linking them, form a pyrrolidine, piperidine, piperazine, morpholine or azepane ring that is unsubstituted or substituted by at least one unsubstituted C₁-C₄alkyl and/or substituted C₁-C₄alkyl, especially a pyrrolidine, piperidine, piperazine, morpholine or azepane ring.

Especially preferred as ligands L are also those of formula (4) and/or (5)

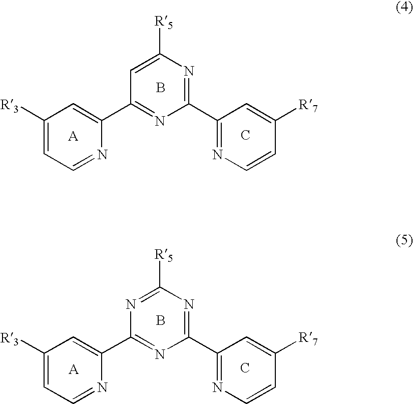

wherein R′₃ and R′₇ are independently from each other hydrogen; C₁-C₄alkoxy; Cl; hydroxy; phenyl; phenyl substituted by OC₁-C₂alkyl, OH or C₁-C₄alkyl; N-mono- or N,N-di-C₁-C₄alkylamino unsubstituted or substituted by hydroxy in the alkyl moiety, wherein the nitrogen atoms, especially the nitrogen atoms that are not bonded to one of the rings A, B and/or C, may be quaternised; or a pyrrolidine, piperidine, piperazine, morpholine or azepane ring unsubstituted or substituted by at least one C₁-C₄alkyl, wherein the amino groups may be quaternised,

R₁₅ is C₁-C₄alkoxy; Cl; hydroxy; phenyl; phenyl substituted by OC₁-C₂alkyl, OH or C₁-C₄alkyl; N-mono- or N,N-di-C₁-C₄alkylamino unsubstituted or substituted by hydroxy in the alkyl moiety, wherein the nitrogen atoms, especially the nitrogen atoms that are not bonded to one of the rings A, B and/or C, may be quaternised; or a pyrrolidine, piperidine, piperazine, morpholine or azepane ring unsubstituted or substituted by at least one C₁-C₄alkyl, wherein the amino groups may be quaternised,

with the proviso that
(i) at least one of the substituents R′₃, R′₅ and R′₇ is one of the radicals

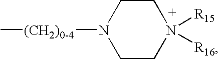

wherein R₁₅ and R₁₈ are independently from each other hydrogen or unsubstituted or substituted C₁-C₄alkyl or unsubstituted or substituted aryl and
wherein the unbranched or branched alkylene group may be unsubstituted or substituted, and wherein the C₁-C₄alkyl groups, which are branched or unbranched independently of one another, may be unsubstituted or substituted and wherein the piperazine ring may be unsubstituted or substituted.

Ligands L to which special preference is given are those of formula (3)

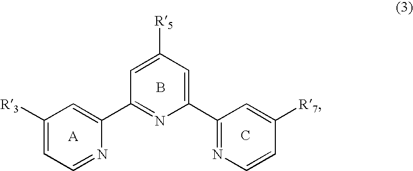

wherein

R′₃ and R′₇ are independently from each other hydrogen;

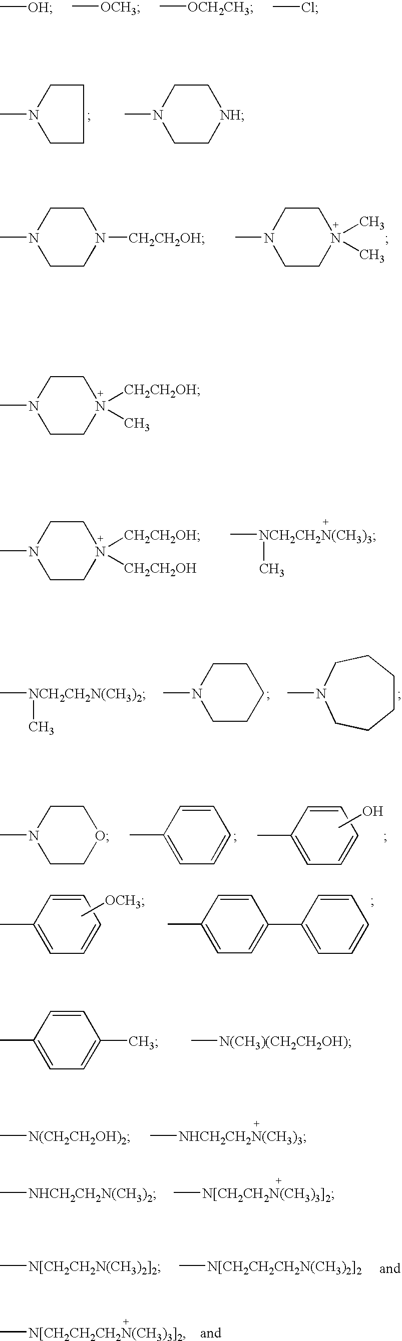

R′₅ is

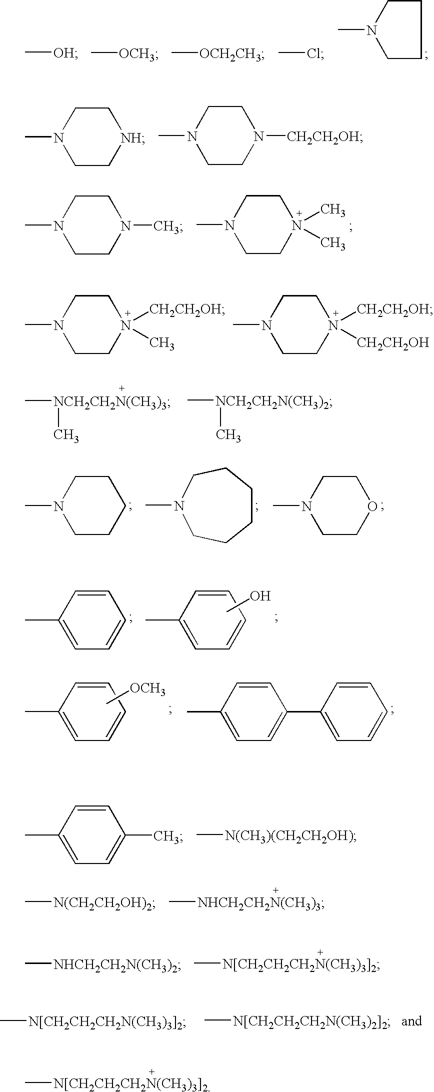

Ligands L to which special preference is also given are those of formula (3)

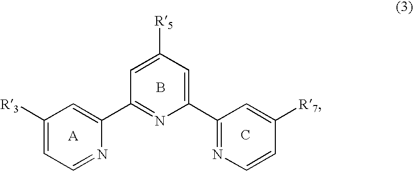

wherein

R′₃ and R′₇ are independently from each other hydrogen;

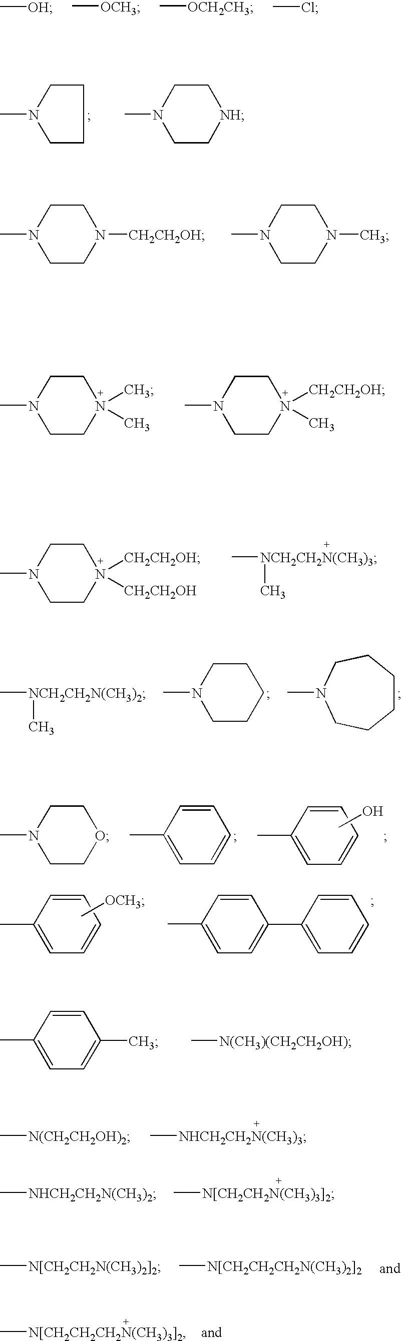

R₁₅ is

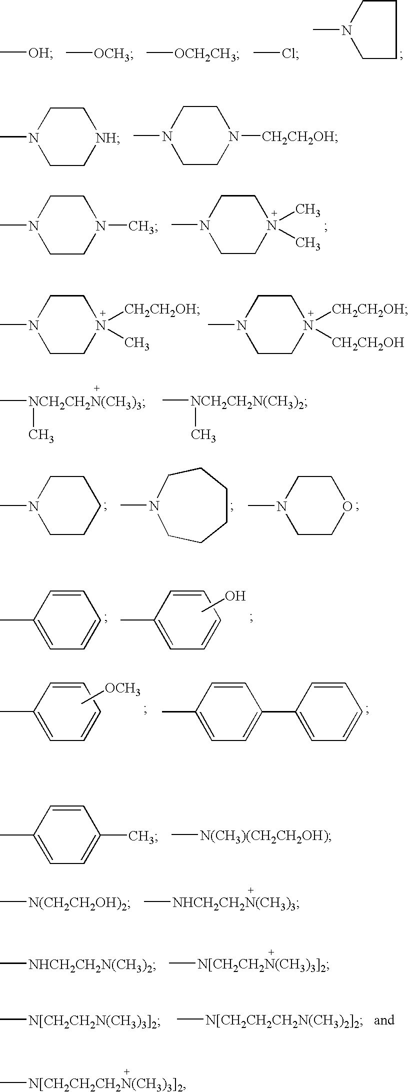

with the proviso that
(i) at least one of the substituents R′₃, R′₅ and R′₇ is one of the radicals

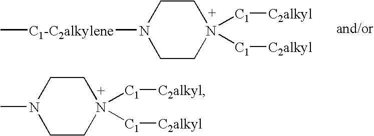

wherein each alkylene group, each alkyl group and each piperazine ring may be independently of each other unsubstituted or substituted.

Ligands L to which special preference is also given are those of formula (4) and/or (5)

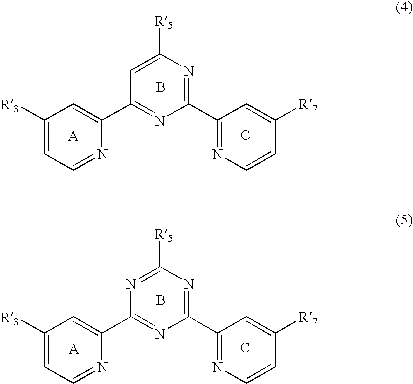

wherein

R′₃ and R′₇ are independently from each other hydrogen;

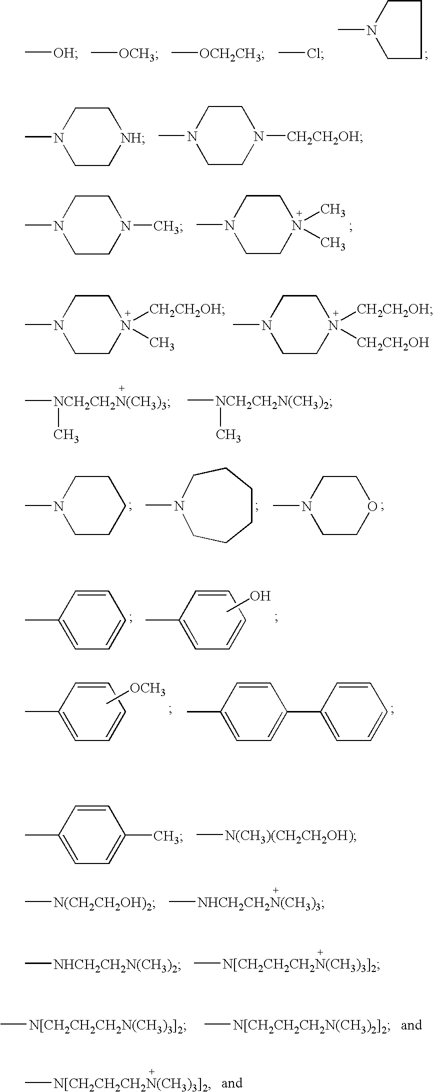

R₁₅ is

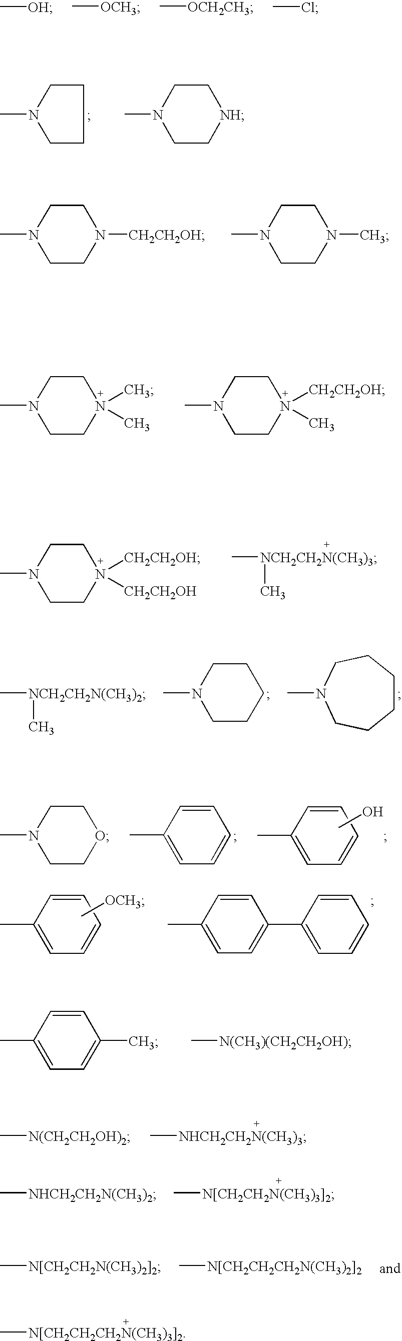

Ligands L to which special preference is also given are those of formula (4) and/or (5)

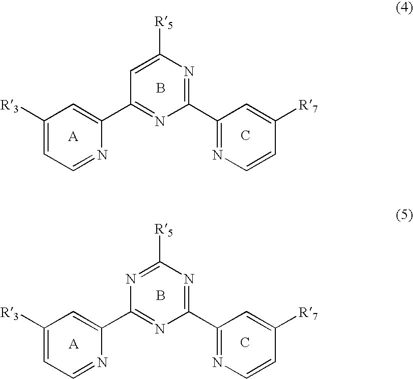

wherein

R′₃ and R′₇ are independently from each other hydrogen;

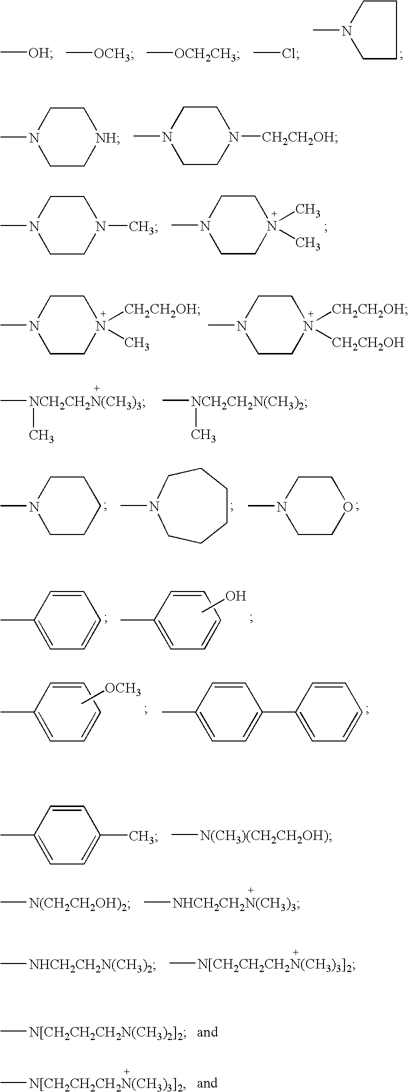

R₁₅ is

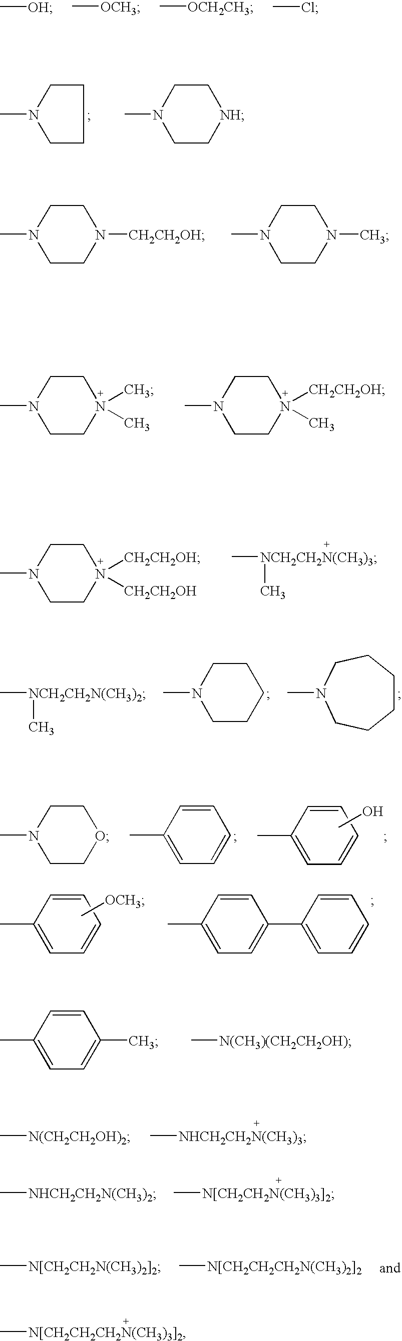

with the proviso that
(i) at least one of the substituents R′₃, R′₅ and R′₇ is one of the radicals

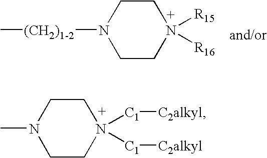

wherein each alkylene group, each alkyl group and each piperazine ring may be independently of each other unsubstituted or substituted.

Preferred as L of formula (2) are compounds in which precisely 0 or 1 quaternised nitrogen atom is present.

Also preferred as L of formula (2) are compounds in which 0, 2 or 3 quaternised nitrogen atoms are present.

Especially preferred as L of formula (2) are compounds in which none of the quaternised nitrogen atoms is bonded directly to one of the three rings A, B and/or C.

As organic peroxy acid any known peroxy acid can be used. For example, mono- or poly-peroxy acids having at least 1 carbon atoms, preferably from 1 to 20 carbon atoms, in the alkyl chain. It is also possible to a precursor of these acids.

Preferred are organic peroxy acids of formula

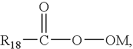

wherein

M signifies hydrogen or a cation,

R₁₈ signifies unsubstituted C₁-C₁₈alkyl; substituted C₁-C₁₈alkyl; unsubstituted aryl; substituted aryl; —C₁-C₆alkylene)-aryl, wherein the alkylene and/or the alkyl group may be substituted; and phthalimidoC₁-C₈alkylene, wherein the phthalimido and/or the alkylene group may be substituted.

The C₁-C₁₈alkyl radicals mentioned are generally, for example, straight-chain or branched alkyl radicals, such as methyl, ethyl, n-propyl, isopropyl, n-butyl, sec-butyl, isobutyl, tert-butyl or straight-chain or branched pentyl, hexyl, heptyl or octyl.

Preference is given to C₁-C₁₂alkyl radicals, especially C₁-C₈alkyl radicals and preferably C₁-C₄alkyl radicals. The mentioned alkyl radicals may be unsubstituted or substituted e.g. by hydroxy, C₁-C₄alkoxy, sulfo or by sulfato.

The corresponding unsubstituted alkyl radicals are preferred. Very special preference is given to methyl and ethyl, especially methyl.

Examples of aryl radicals that generally come into consideration are phenyl or naphthyl each unsubstituted or substituted by C₁-C₄alkyl, C₁-C₄alkoxy, halogen, cyano, nitro, carboxy, sulfo, hydroxy, amino, N-mono- or N,N-di-C₁-C₄alkylamino unsubstituted or substituted by hydroxy in the alkyl moiety, N-phenylamino, N-naphthylamino, phenyl, phenoxy or by naphthyloxy. Preferred substituents are C₁-C₄alkyl, C₁-C₄alkoxy, phenyl and hydroxy.

The C₁-C₆alkylene groups mentioned are, for example, straight-chain or branched alkylene radicals, such as methylene, ethylene, n-propylene or n-butylene. C₁-C₄alkylene groups are preferred. The alkylene radicals mentioned may be unsubstituted or substituted, for example by hydroxy or C₁-C₄alkoxy.

The cation M can be any suitable cation or mixtures of cations. Examples of cations that generally come into consideration are alkali metal cations, such as lithium, potassium and especially sodium, alkaline earth metal cations, such as magnesium and calcium, and ammonium cations. The alkali metal cations, especially sodium, are preferred.

Very preferred organic peroxy acids and their salts are those of formula

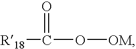

wherein

M signifies hydrogen or an alkali metal, and

R′₁₈ is signifies unsubstituted C₁-C₄alkyl; phenyl; —C₁-C₂alkylene-phenyl or phthalimidoC₁-C₈alkylene.

Especially preferred is CH₃COOOH and its alkali salts.

Especially preferred is also ε-phthalimido peroxy hexanoic acid and its alkali salts.

Inorganic peroxy acid compounds, such as for example potassium monopersulphate, can also be used.

The amount of peroxy acid used in deaning formulations will normally be within the range of about 2-20% by weight (wt-%), preferably between 4-12 wt-%.

Instead of the peroxy acid it is also possible to use peroxy acid precursors and H₂O₂ (as well as precursors of H₂O₂). Such precursors are the corresponding carboxyacid or the corresponding carboxyanhydrid or the corresponding carbonylchlorid, or amides, or esters, which can form the peroxy adds on perhydrolysis. Such reactions are commonly known.

Peroxyacid bleach precursors are known and amply described in literature, such as in the British Patents 836988; 864,798; 907,356; 1,003,310 and 1,519,351; German Patent 3,337,921; EP-A-0185522; EP-A-0174132; EP-A-0120591; and U.S. Pat. Nos. 1,246,339; 3,332,882; 4,128,494; 4,412,934 and 4,675,393.

A preferred group of bleach activators comprises compounds that, under perhydrolysis conditions, yield unsubstituted or substituted perbenzo- and/or peroxo-carboxylic acids having from 1 to 12 carbon atoms, especially from 2 to 4 carbon atoms. Suitable bleach activators include the customary bleach activators that carry O- and/or N-acyl groups having the indicated number of carbon atoms and/or unsubstituted or substituted benzoyl groups.

Preference is given to polyacylated alkylenediamines, especially tetraacetylethylenediamine (TAED), acylated glycolurils, especially tetraacetylglycoluril (TAGU), N,N-diacetyl-N,N-dimethylurea (DDU), acylated triazine derivatives, especially 1,5-diacetyl-2,4-dioxohexahydro-1,3,5-triazine (DADHT), compounds of formula (6):

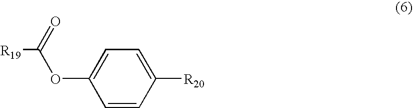

wherein R₂₀ is a sulfonate group, a carboxylic acid group or a carboxylate group, and wherein R₁₉ is linear or branched (C₇-C₁₅)alkyl, especially activators known under the names SNOBS, SLOBS and DOBA, acylated polyhydric alcohols, especially triacetin, ethylene glycol diacetate and 2,5-diacetoxy-2,5-dihydrofuran, and also acetylated sorbitol and mannitol and acylated sugar derivatives, especially pentaacetylglucose (PAG), sucrose polyacetate (SUPA), pentaacetylfructose, tetraacetylxylose and octaacetyllactose as well as acetylated, optionally N-alkylated glucamine and gluconolactone. It is also possible to use the combinations of conventional bleach activators known from German Patent Application DE-A4443177.

Especially preferred is the use of the catalyst of the present invention together with a combination of TAED and/or SNOBS with percarbonate and/or perborate.

Another useful class of peroxyacid bleach precursors is that of the cationic i.e. quaternary ammonium substituted peroxyacid precursors as disclosed in U.S. Pat. Nos. 4,751,015 and 4,397,757, in EP-A0284292 and EP-A-331,229. Examples of peroxyacid bleach precursors of this class are: 2-(N,N,N-trimethyl ammonium) ethyl sodium-4-sulphophenyl carbonate chloride-(SPCC), N-Octyl-N,N-dimethyl-N-[10(phenoxycarbonyl)decyl]ammonium chloride-(ODC), 3-(N,N,N-trimethyl ammonium) propyl sodiumsulphophenyl carboxylate and N,N,N-trimethyl ammonium toluoyloxy benzene sulphonate.

A further special class of bleach precursors is formed by the cationic nitriles as disclosed in EP-A-303,520, WO 96/40661 and in European Patent Specification No.'s 458,396, 790244 and 464,880. These cationic nitriles also known as nitrile quats have the following formula

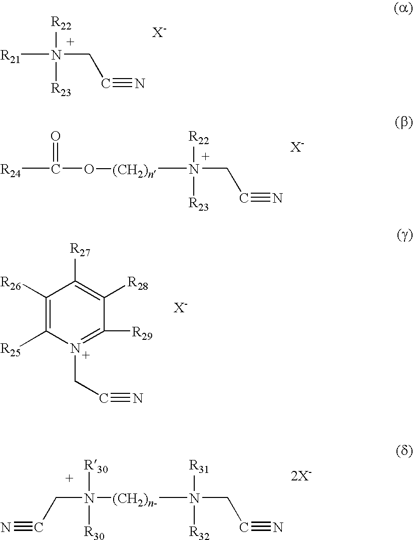

wherein
R₂₁ is C₁-C₂₄alkyl; C₁-C₂₄alkenyl; alkaryl having a Cl₁-C₂₄alkyl; substituted ClC₄alkyl; substituted C₁-C₂alkenyl or substituted aryl,
R₂₂ and R₂₃ are each independently C₁-C₃alkyl; hydroxyalkyl having 1 to 3 carbon atoms, —(C₂H₄O)ₙH, n being 1 to 6; —CH₂—CN
R₂₄ is C₁-C₂₀alkyl; C₁-C₂₀alkenyl; substituted C₁-C₂₀alkyl; substituted C₁-C₂₀alkenyl; alkaryl having a C₁-C₂₄alkyl and at least one other substituent,
R₂₅, R₂₆, R₂₇, R₂₈ and R₂₉ are each independently hydrogen; C₁-C₁₀alkyl; C₁-C₁₀alkenyl; substituted C₁-C₁₀alkyl; substituted C₁-C₁₀alkenyl; carboxyl; sulfonyl or cyano
R₃₀, R′₃₀, R₃₁ and R₃₂ are each independently C₁-C₆ alkyl,

n′ is an integer from 1 to 3,

n″ is an integer from 1 to 16, and

X is an anion.

Other nitrile quats have the following formula

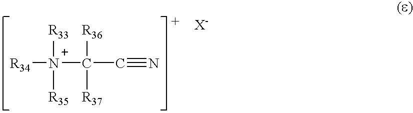

wherein
R₃₃ and R₃₄ form, together with the nitrogen atom to which they are bonded, a ring comprising 4 to 6 carbon atoms, this ring may also be substituted by C₁-C₆-alkyl, C₁-C₅-alkoxy, C₁-C₆-alkanoyl, phenyl, amino, ammonium, cyano, cyanamino or chloro and 1 or 2 carbon atom(s) of this ring may also be substituted by a nitrogen atom, by an oxygen atom, by a N—R₃₈-group and/or by a R₃₅—N—R₃₈-group, wherein R₃₅ is hydrogen, C₁-C₅alkyl, C₂-C₅alkenyl, C₂-C₅alkinyl, phenyl, C₇-C₉aralkyl, C₅-C₇cycloalkyl, C₁-C₅alkanoyl, cyanomethyl or cyano,
R₃₅ is C₁-C₂₄alkyl, preferably C₁-C₄alkyl, C₂-C₂₄-alkenyl, preferably C₂-C₄-alkenyl, cyanomethyl or C₁-C₄-alkoxy-C₁-C₄-alkyl,
R₃₆ and R₃₇ are independently from each other hydrogen; C₁-C₄-alkyl; C₁-C₄-alkenyl; C₁-C₄-alkoxy-C₁-C₄-alkyl; phenyl or C₁-C₃alkylphenyl, preferably hydrogen; methyl or phenyl, whereby preferably the moiety R₃₈ signifies hydrogen, if R₃₇ is not hydrogen, and
X⁻ is an anion.

Suitable examples of nitrile quats of formula (ε) are

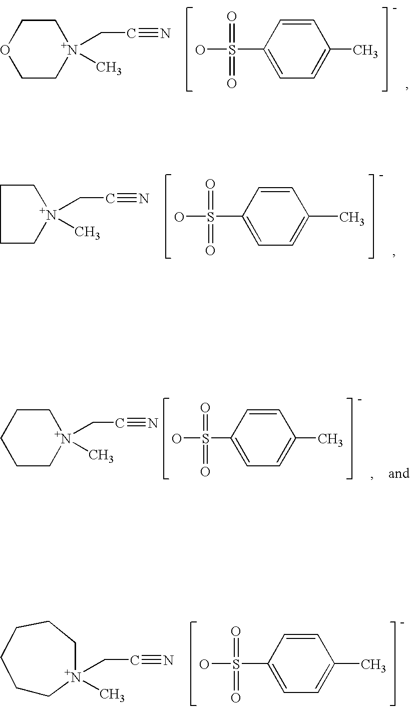

Any one of these peroxyacid bleach precursors can be used in the present invention, though some may be more preferred than others.

The precursors may be used in an amount of up to 20%, preferably from 2-10% by weight, of the composition.

Metal complex compounds of formula (1) are known (e.g. from WO 02/088289) or can be obtained analogously to known processes. They are obtained in a manner known per se by reacting at least one ligand L of formula (2) in the desired molar ratio with a metal compound, especially a metal salt, such as the chloride, to form the corresponding metal complex. The reaction is carried out, for example, in a solvent, such as water or a lower alcohol, such as ethanol, at a temperature of, for example, from 10 to 60° C., especially at room temperature.

The metal complex compounds of formula (1), wherein the ligands L of formula (2) comprise quaternized nitrogen moieties can be prepared according to methods known per se. Such methods are described in K. T. Potts, D. Konwar, J. Org. Chem. 2000, 56, 4815-4816, E. C. Constable, M. D. Ward, J. Chem. Soc. Dalton Trans. 1990, 1405-1409, E. C. Constable, A. M. W. Cargill Thompson, New. J. Chem. 1992, 16, 855867, G. Lowe et al., J. Med. Chem., 1999, 42, 999-1006, E. C. Constable, P. Harveson, D. R. Smith, L. Whall, Polyhedron 1997, 16, 3615-3623, R. J. Sundberg, S. Jiang, Org. Prep. Proced. Int. 1997, 29, 117-122, T. Sammakia, T. B. Hurley, J. Org. Chem. 2000, 65, 974-978 and J. Limburg et al., Science 1999, 283, 1524-1527.

Ligands of formula (2) that are substituted by hydroxy can also be represented as compounds having a pyridone structure in accordance with the following scheme (illustrated here using the example of a ligand of formula (2) substituted by hydroxy in the 4′-position):

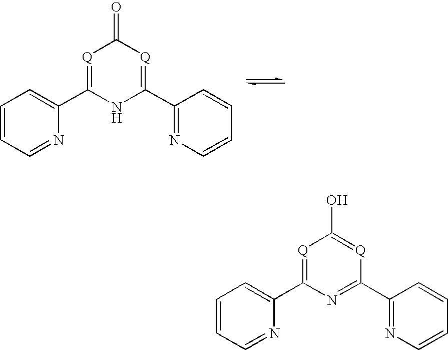

The special position of the above-mentioned hydroxy-substituted compounds is due to the fact that those ligands can be deprotonated and are therefore able to function as anionic ligands.

Generally, therefore, hydroxy-substituted compounds are also to be understood as including those having a corresponding pyridone structure.

Ligands of formula (3) can also be prepared in a manner known per se. Such preparation procedures are described, for example, in J. Chem. Soc., Dalton Trans. 1990, 1405-1409 (E. C. Constable et al.) and New. J. Chem. 1992, 16, 855-867.

Ligands of formulae (4) are known or can be prepared in a manner known per se [F. H. Case et al., J. Org. Chem. 1967, 32(5), 1591-1596]). For that purpose, for example, one part pyridine-2-carboxylate and one part ethyl acetate can be reacted with sodium hydride, and the intermediate obtained after aqueous working-up, a β-keto ester, reacted with 2-amidinopyridine, yielding the corresponding pyrimidine derivative which can be converted into the chlorine compounds by reaction with a chlorinating agent, such as, for example, PCI₅/POCl₃. Reaction of those compounds with amines, as desired in the presence of an excess of redox-active salts of transition metals, such as manganese, iron or ruthenium, in order to accelerate substitution, yields amine-substituted bispyridyl-pyrimidines. Preparation procedures using the latter two metal ions are described, for example, in J. Chem. Soc., Dalton Trans. 1990, 1405-1409 (E. C. Constable et al.) and New. J. Chem. 1992, 16, 855-867.

It has now been found that, in order to accelerate replacement of halide by amine on the bispyridyl-pyrimidine structure, it is also possible to use catalytic amounts of non-transition metal salts, such as, for example, zinc(II) salts, which substantially simplifies the reaction procedure and working-up.

Ligands of formula (4) can be prepared analogously to known processes (e.g. Patent Applications EP 555 180 and EP 556 156 or F. H. Case et al., J. Am. Chem. Soc. 1959, 81, 905-906), by reacting two parts 2-cyanopyridine with urea or guanidine and a base.

The metal complex compounds of formula (1) are used together with peroxy adds and/or precursors of peroxy acids and H₂O₂ and/or precursors of H₂O₂. Examples that may be mentioned in that regard include the following uses:
a) the bleaching of stains or of soiling on textile material in the context of a washing process or by the direct application of a stain remover;
b) the prevention of redeposition of migrating dyes during the washing of textile material;
c) the cleaning of hard surfaces, especially kitchen surfaces, wall tiles or floor tiles, for example to remove stains that have formed as a result of the action of moulds (“mould stains”); (automatic) dishwasher formulation can also be prepared;
d) use in washing and cleaning solutions having an antibacterial action;
e) as pretreatment agents for bleaching textiles;
f) as catalysts in selective oxidation reactions in the context of organic synthesis;
g) waste water treatment;
h) sterilisation and
i) contact lens disinfection.

A further use is concerned with the use of the metal complex compounds of formula (1) as catalysts for reactions using peroxy acids and/or peroxyacid precursor for bleaching in the context of paper-making. This relates especially to the delignfication of cellulose and bleaching of the pulp, which can be carried out in accordance with customary procedures. Also of interest is the use of the metal complex compounds of formula (1) as catalysts for reactions using peroxy acids for the bleaching of waste printed paper.

It should be emphasised that the use of metal complex compounds, for example, in the bleaching of textile material, does not cause any appreciable damage to fibres and dyeings.

Processes for bleaching stains in a washing liquor are usually carried out by adding to the washing liquor (which comprises a peroxy acid or their precursor together with H₂O₂ or a precursor of H₂O₂) one or more metal complex compounds of formula (1). Alternatively, it is possible to add a detergent that already comprises one or two metal complex compounds. It will be understood that in such an application, as well as in the other applications, the metal complex compounds of formula (1) can alternatively be formed in situ, the metal salt (e.g. manganese(II) salt, such as manganese(II) chloride, and/or iron(II) salt, such as iron(II) chloride) and the ligand being added in the desired molar ratios.

The present invention relates also to a detergent, cleaning, disinfecting or bleaching composition containing
I) from 0 to 50 wt-%, preferably from 0 to 30 wt-%, A) of at least one anionic surfactant and/or B) of at least one non-ionic surfactant,
II) from 0 to 70 wt-%, preferably from 0 to 50 wt-%, C) of at least one builder substance,
III) from 1 to 99 wt-%, preferably from 1 to 50 wt-%, D) of at least one peroxy acid and/or at least one precursors of peroxy acid, the latter in combination with hydrogen peroxide and/or a precursor of hydrogen peroxide,
IV) E) at least one metal complex compound of formula (1) in an amount that, in the liquor, gives a concentration of from 0.5 to 100 mg/litre of liquor, preferably from 1 to 50 mg/litre of liquor, when from 0.5 to 50 g/litre of the detergent, cleaning, disinfecting or bleaching agent are added to the liquor, and
V) water ad 100 wt-%.

The present invention relates also to a preferred detergent, cleaning, disinfecting or bleaching composition containing
I) from 0 to 50 wt-%, preferably from 0 to 30 wt-%, A) of at least one anionic surfactant and/or B) of at least one non-ionic surfactant,
II) from 0 to 70 wt-%, preferably from 0 to 50 wt-%, C) of at least one builder substance,
III) from 1 to 99 wt-%, preferably from 1 to 50 wt-%, D) of at least one peroxy acid and/or at least one precursors of peroxy acid, having at least from 1 to 20 carbon atoms, in the alkyl chain, the precursors of peroxy acid in combination with hydrogen peroxide and/or a precursor of hydrogen peroxide,
IV) E) at least one manganese complex compound of formula (1) comprising a ligand of formula (3), (4) and/or (5)
   in an amount that, in the liquor, gives a concentration of from 0.5 to 100 mg/litre of liquor, preferably from 1 to 50 mg/litre of liquor, when from 0.5 to 50 g/litre of the detergent, cleaning, disinfecting or bleaching agent are added to the liquor, and
V) water ad 100 wt-%.

The present invention relates also to a more preferred detergent, cleaning, disinfecting or bleaching composition containing
I) from 0 to 50 wt-%, preferably from 0 to 30 wt-%, A) of at least one anionic surfactant and/or B) of at least one non-ionic surfactant,
II) from 0 to 70 wt-%, preferably from 0 to 50 wt-%, C) of at least one builder substance,
III) from 1 to-99 wt-%, preferably from 1 to 50 wt-%, D) of at least one peroxy acid of
   formula

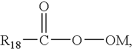

wherein M signifies hydrogen or a cation,
R₁₈ signifies unsubstituted C₁-C₁₈alkyl; substituted C₁-C₁₈alkyl; unsubstituted aryl; substituted aryl; —(C₁-C₆alkylene)-aryl, wherein the alkylene and/or the alkyl group may be substituted; and phthalimidoC₁-C₈alkylene, wherein the phthalimido and/or the alkylene group may be substituted and/or at least one-precursors of peroxy acid in combination with hydrogen peroxide and/or a precursor of hydrogen peroxide,
IV) E) at least one manganese complex compound of formula (1) comprising a ligand of formula (3), (4) and/or (5) in an amount that, in the liquor, gives a concentration of from 0.5 to 100 mg/litre of liquor, preferably from 1 to 50 mg/litre of liquor, when from 0.5 to 50 g/litre of the detergent, cleaning, disinfecting or bleaching agent are added to the liquor, and
V) water ad 100 wt-%.

The present invention relates also to an especially preferred detergent, cleaning, disinfecting or bleaching composition containing
I) from 0 to 50 wt-%, preferably from 0 to 30 wt-%, A) of at least one anionic surfactant and/or B) of at least one non-ionic surfactant,
II) from 0 to 70 wt-%, preferably from 0 to 50 wt-%, C) of at least one builder substance,
III) from 1 to 99 wt-%, preferably from 1 to 50 wt-%, D) of at least one peroxy acid of formula

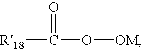

wherein M signifies hydrogen or an alkali metal, and
R′₁₈ signifies unsubstituted C₁-C₄alkyl; phenyl; —C₁-C₂alkylene-phenyl or phthalimidoC₁-C₈alkylene and/or at least one precursors of the peroxy acid in combination with hydrogen peroxide and/or a precursor of hydrogen peroxide,
IV) E) at least one manganese complex compound of formula (1) comprising a ligand of formula (3), (4) and/or (5) in an amount that, in the liquor, gives a concentration of from 0.5 to 100 mg/litre of liquor, preferably from 1 to 50 mg/litre of liquor, when from 0.5 to 50 g/litre of the detergent, cleaning, disinfecting or bleaching agent are added to the liquor, and
V) water ad 100 wt-%.

The present invention relates also to a very especially preferred detergent, cleaning, disinfecting or bleaching composition containing
I) from 0 to 50 wt-%, preferably from 0 to 30 wt-%, A) of at least one anionic surfactant and/or B) of at least one non-ionic surfactant,
II) from 0 to 70 wt-%, preferably from 0 to 50 wt-%, C) of at least one builder substance,
III) from 1 to 99 wt-%, preferably from 1 to 50 wt-%, D) of CH₃COOOH and/or of ε-phthalimido peroxy hexanoic acid or their alkali salts,
IV) E) at least one manganese complex compound of formula (1) comprising a ligand of formula (3), (4) and/or (5) in an amount that, in the liquor, gives a concentration of from 0.5 to 100 mg/litre of liquor, preferably from 1 to 50 mg/litre of liquor, when from 0.5 to 50 g/litre of the detergent, cleaning, disinfecting or bleaching agent are added to the liquor, and
V) water ad 100 wt-%.

The present invention relates also to a further very especially preferred detergent, cleaning, disinfecting or bleaching composition containing
I) from 0 to 50 wt-%, preferably from 0 to 30 wt-%, A) of at least one anionic surfactant and/or B) of at least one non-ionic surfactant,
II) from 0 to 70 wt-%, preferably from 0 to 50 wt-%, C) of at least one builder substance,
III) from 1 to 20 wt-% of TAED or NOBS as precursors of peroxy acids and from 1 to 90 wt-% of sodium percarbonate and/or sodium perborate,
IV) E) at least one manganese complex compound of formula (1) comprising a ligand of formula (3), (4) and/or (5) in an amount that, in the liquor, gives a concentration of from 0.5 to 100 mg/litre of liquor, preferably from 1 to 50 mg/litre of liquor, when from 0.5 to 50 g/litre of the detergent, cleaning, disinfecting or bleaching agent are added to the liquor, and
V) water ad 100 wt-%.

For the ligands of formulae (3), (4) and/or (5) [component E] all preferences as defined above apply for each detergent, cleaning, disinfecting or bleaching composition.

The above percentages are in each case percentages by weight, based on the total weight of the composition. The compositions preferably contain from 0.005 to 2 wt-% of at least one metal complex compound of formula (1), especially from 0.01 to 1 wt-% and preferably from 0.05 to 1 wt-%.

When the compositions according to the invention comprise a component A) and/or B), the amount thereof is preferably from 1 to 50 wt-%, especially from 1 to 30 wt-%.

When the compositions according to the invention comprise a component C), the amount thereof is preferably from 1 to 70 wt-%, especially from 1 to 50 wt-%. Special preference is given to an amount of from 5 to 50 wt-% and especially an amount of from 10 to 50 wt-%.

Corresponding washing, cleaning, disinfecting or bleaching processes are usually carried out by using an aqueous liquor containing from 0.1 to 200 mg of one or more compounds of formula (1) per litre of liquor. The liquor preferably contains from 0.5 to 20 mg of at least one compound of formula (1) per litre of liquor.

The composition according to the invention can be, for example, a peroxy acid or peroxy acid precursor containing heavy-duty detergent or a separate bleaching additive, or a stain remover that is to be applied directly. A bleaching additive is used for removing coloured stains on textiles in a separate liquor before the clothes are washed with a bleach-free detergent. A bleaching additive can also be used in a liquor together with a bleach-free detergent.

Stain removers can be applied directly to the textile in question and are used especially for pretreatment in the event of heavy local soiling. The stain remover can be applied in liquid form, by a spraying method or in the form of a solid substance.

Granules can be prepared, for example, by first preparing an initial powder by spray-drying an aqueous suspension comprising all the components listed above except for component E), and then adding the dry component E) and mixing everything together. It is also possible to add component E) to an aqueous suspension containing components A), B), C) and D) and then to carry out spray-drying.

It is also possible to start with an aqueous suspension that contains components A) and C), but none or only some of component B). The suspension is spray-dried, then component E) is mixed with component B) and added, and then component D) is mixed in the dry state. It is also possible to mix all the components together in the dry state.

The anionic surfactant A) can be, for example, a sulfate, sulfonate or carboxylate surfactant ora mixture thereof. Preference is given to alkylbenzenesulfonates, alkyl sulfates, alkyl ether sulfates, olefin sulfonates, fatty acid salts, alkyl and alkenyl ether carboxylates or to an α-sulfonic fatty acid salt or an ester thereof.

Preferred sulfonates are, for example, alkylbenzenesulfonates having from 10 to 20 carbon atoms in the alkyl radical, alkyl sulfates having from 8 to 18 carbon atoms in the alkyl radical, alkyl ether sulfates having from 8 to 18 carbon atoms in the alkyl radical, and fatty acid salts derived from palm oil or tallow and having from 8 to 18 carbon atoms in the alkyl moiety. The average molar number of ethylene oxide units added to the alkyl ether sulfates is from 1 to 20, preferably from 1 to 10. The cation in the anionic surfactants is preferably an alkaline metal cation, especially sodium or potassium, more especially sodium. Preferred carboxylates are alkali metal sarcosinates of formula R₄₄—CON(R₄₅)CH₂COOM₁ wherein R₄₄ is C₈-C₁₇alkyl or C₉-C₁₇alkenyl, R₄₅ is C₁-C₄alkyl and M₁ is an alkali metal, especially sodium.

The non-ionic surfactant may be, for example, a primary or secondary alcohol ethoxylate, especially a C₈-C₂₀ aliphatic alcohol ethoxylated with an average of from 1 to 20 mol of ethylene oxide per alcohol group. Preference is given to primary and secondary C₁₀-C₁₅ aliphatic alcohols ethoxylated with an average of from 1 to 10 mol of ethylene oxide per alcohol group. Non-ethoxylated non-ionic surfactants, for example alkylpolyglycosides, glycerol monoethers and polyhydroxyamides (glucamide), may likewise be used.

The total amount of anionic and non-ionic surfactants is preferably from 1 to 50 wt-%, especially from 5 to 40 wt-% and more especially from 5 to 30 wt-%. The lower limit of those surfactants to which even greater preference is given is 10 wt-%.

As builder substance C) there come into consideration, for example, alkali metal phosphates, especially tripolyphosphates, carbonates and hydrogen carbonates, especially their sodium salts, silicates, aluminum silicates, polycarboxylates, polycarboxylic acids, organic phosphonates, aminoalkylenepoly(alkylenephosphonates) and mixtures of such compounds.

Silicates that are especially suitable are sodium salts of crystalline layered silicates of the formula NaHSiₜO₂ₜ₊₁.pH₂O or Na₂SiₜO₂ₜ₊₁.pH₂O wherein t is a number from 1.9 to 4 and p is a number from 0 to 20.

Among the aluminum silicates, preference is given to those commercially available under the names zeolite A, B, X and HS, and also to mixtures comprising two or more such components. Special preference is given to zeolite A.

Among the polycarboxylates, preference is given to polyhydroxycarboxylates, especially citrates, and acrylates, and also to copolymers thereof with maleic anhydride. Preferred polycarboxylic acids are nitrilotriacetic acid, ethylenediaminetetraacetic acid and ethylene-diamine disuccinate either in racemic form or in the enantiomerically pure (S,S) form.

Phosphonates or aminoalkylenepoly(alkylenephosphonates) that are especially suitable are alkali metal salts of 1-hydroxyethane-1,1-diphosphonic acid, nltrilotris(methylenephosphonic acid), ethylenediaminetetramethylenephosphonic acid and diethylenetriaminepenta-methylenephosphonic acid, and also salts thereof.

The amount of peroxy acid and/or of a combination of a peroxy acid precursor and H₂O₂ and/or precursors of H₂O₂ is preferably from 0.5 to 30 wt-%, preferably from 1 to 20 wt-% and more preferably from 1 to 15 wt-%.

If peroxy acids are formed from precursors, hydrogen peroxide or a precursor of hydrogen peroxide must be present for perhydrolysis. Precursors of peroxides are preferentially used that release hydrogen peroxide in aqueous solution. Examples include persulfates, perborates, percarbonates and/or persilicates. More specific examples of suitable inorganic peroxides are sodium perborate tetrahydrate, sodium perborated monohydrate, sodium percarbonate. Inorganic peroxyacid compounds, such as potassium monopersulphate, are also possible. It will be understood that mixtures of inorganic and/or organic peroxides can also be used. The peroxides may be in a variety of crystalline forms and have different water contents, and they may also be used together with other inorganic or organic compounds in order to improve their storage stability. The typical amount of persalts in the detergent or cleaning formulation are preferably between 2 and 90%, more preferably between 5 and 25 wt %.

The compositions may comprise, in addition to the combination according to the invention, one or more optical brighteners, for example from the classes bis-triazinylamino stilbenedisulfonic acid, bis-triazolyl-stilbenedisulfonic acid, bis-styryl-biphenyl or bis-benzofuranylbiphenyl, a bis-benzoxalyl derivative, bis-benzimidazolyl derivative or coumarin derivative or a pyrazoline derivative.

The compositions may furthermore comprise one or more auxiliaries. Such auxiliaries are, for example, dirt-suspending agents, for example sodium carboxymethylcellulose; pH regulators, for example alkali metal or alkaline earth metal silicates; foam regulators, for example soap; salts for adjusting the spray drying and the granulating properties, for example sodium sulfate; perfumes; and also, if appropriate, antistatics and softening agents such as, for example, smectite; bleaching agents; pigments; and/or toning agents. These constituents should especially be stable to any bleaching agent employed. Such auxiliaries are added in a total amount of from 0.1 to 20 wt-%, preferably from 0.5 to 10 wt-%, especially from 0.5 to 5 wt-%, based on the total weight of the detergent formulation.

Furthermore, the detergent may optionally also comprise enzymes. Enzymes can be added for the purpose of stain removal. The enzymes usually improve the action on stains caused by protein or starch, such as, for example, blood, milk, grass or fruit juices. Preferred enzymes are amylases and proteases, especially proteases. Other preferred enzymes include lipases, cellulases and mannanases.

Amylases: The present invention preferably makes use of amylases having improved stability in detergents, especially improved oxidative stability. Such amylases are non-limitingly illustrated by the following: (a) An amylase according to WO 94/02597, Novo Nordisk A/S as further illustrated by a mutant in which substitution is made, using alanine or threonine (preferably threonine), of the methionine residue located in position 197 of the B. licheniformis alpha-amylase, known as TERMAMYL®, or the homologous position variation of a similar parent amylase, such as B. amyloliquefadens, B. subtilis, or B. stearothermophilus; (b) Stability-enhanced amylases as described by Genencor International in a paper entitled “Oxidatively Resistant α-Amylases” presented at the 207th American Chemical Society National Meeting, Mar. 13-17 1994, by C. Mitchinson. Therein it was noted that bleaches in automatic dishwashing detergents inactivate alpha-amylases but that improved oxidative stability amylases have been made by Genencor from B. licheniformis NCIB8061. Other commercially available detergent amylases, such as Duramyl®, Stainzyme®, Natalase®, Ban® and Fungamyl®, are sold e.g. by NOVOZYMES A/S. Any other oxidative stability-enhanced amylase can be used.

Proteases: Protease enzymes are usually present in preferred embodiments of the invention at levels between 0.001 wt-% and 5 wt-%. The proteolytic enzyme can be of animal, vegetable or microorganism (preferred) origin. More preferred is serine proteolytic enzyme of bacterial origin. Purified or nonpurified forms of enzyme may be used. Proteolytic enzymes produced by chemically or genetically modified mutants are included by definition, as are close structural enzyme variants. Suitable commercial proteolytic enzymes include Alcalase®, Esperase®, Everdase®, Durazyme®, Savinase®, Maxatase®, Kannase®, Maxacal®, and Maxapem® 15 (protein engineered Maxacal). Purafect® and subtilising BPN and BPN′ are also commercially available.

Lipase: Lipases work on greasy soil and stains. When present, lipases comprise from about 0.001 wt-% to about 5 wt-% of the detergent or cleaning formulation. Suitable lipases for use herein include those of bacterial, animal and fungal origin, including those from chemically or genetically modified mutants. Commercially available detergent lipases, such as Lipolase®, Lipolase Ultra® and Lipoprime® are sold e.g. by NOVOZYMES A/S.

When incorporating lipases into the instant compositions, their stability and effectiveness may in certain instances be enhanced by combining them with small amounts (e.g., less than 0.5 wt-% of the composition) of oily but non-hydrolyzing materials.

Cellulases: Cellulases are enzymes that react with cellulose and its derivatives and hydrolyse them to form glucose, cellobiose and cellooligosaccharides. Cellulases remove dirt and, in addition, have the effect of enhancing the soft handle of the fabric and reduce graying. Commercially available cellulases, such as Celluzyme®, Careuyme® and Endolase® are, are sold e.g. by NOVOZYMES A/V. The enzymes, when used, may be present in a total amount of from 0.01 to 5% by weight, especially from 0.05 to 5 wt-% and more especially from 0.1 to 4 wt-%, based on the total weight of the detergent formulation.

In a hardsurface cleaner, especially in a composition used for automatic dishwasher the following enzymes are also commonly used: proteases, amylases, pullulanases, cutinases and lipases, for example proteases such as BLAP®, Optimase®, Opticlean®, Maxacal®, Maxapem®, Esperase® and/or Savinase® amylases such as Termamyl®, Amylase-LT®, Maxamyl® and/or Duramyl®, lipases such as Lipolase®, Lipomax®, Lumafast® and/or Lipozym®.

The enzymes which may be used can, as described e.g. in International Patent Applications WO 92/11347 and WO 94/23005, be adsorbed on carriers and/or embedded in encapsulating substances in order to safeguard them against premature inactivation. They are present in the cleaning formulations according to the invention preferably in amounts not exceeding 5 wt-%, especially in amounts of from 0.1 wt-% to 1.2 wt-%.

In order to enhance the bleaching action, the compositions may, in addition to the catalysts described herein, also comprise photocatalysts the action of which is based on the generation of singlet oxygen.

Further preferred additives to the compositions according to the invention are dye-fixing agents and/or polymers which, during the washing of textiles, prevent staining caused by dyes in the washing liquor that have been released from the textiles under the washing conditions. Such polymers are preferably polyvinylpyrrolidones, polyvinylimidazoles or polyvinylpyridine-N-oxides, which may have been modified by the incorporation of anionic or cationic substituents, especially those having a molecular weight in the range of from 5000 to 60 000, more especially from 10 000 to 50 000. Such polymers are usually used in a total amount of from 0.01 to 5 wt-%, especially from 0.05 to 5 wt-%, more especially from 0.1 to 2 wt-%, based on the total weight of the detergent formulation. Preferred polymers are those mentioned in WO-A-02/02865 (see especially page 1, last paragraph and page 2, first paragraph).

The detergent formulations can take a variety of physical forms such as, for example, powder granules, tablets (tabs) and liquid. Examples thereof include, inter alia, conventional high-performance detergent powders, supercompact high-performance detergent powders and tabs. One important physical form is the so-called concentrated granular form, which is added to a washing machine.

Also of importance are so-called compact or supercompact detergents. In the field of detergent manufacture, there is a trend towards the production of such detergents that contain an increased amount of active substances. In order to minimize energy consumption during the washing procedure, compact or supercompact detergents need to act effectively at low washing temperatures, for example below 40° C., or even at room temperature (25° C.). Such detergents usually contain only small amounts of fillers or of substances, such as sodium sulfate or sodium chloride, required for detergent manufacture. The total amount of such substances is usually from 0 to 10 wt-%, especially from 0 to 5 wt-%, more especially from 0 to 1 wt-%, based on the total weight of the detergent formulation. Such (super)compact detergents usually have a bulk density of from 650 to 1000 g9/, especially from 700 to 1000 g/l and more especially from 750 to 1000 g/l.

The detergent formulations can also be in the form of tablets (tabs). The advantages of tabs reside in the ease of dispensing and convenience in handling. Tabs are the most compact form of solid detergent formulation and usually have a volumetric density of, for example, from 0.9 to 1.3 kg/litre. To achieve rapid dissolution, such tabs generally contain special dissolution aids:
carbonate/hydrogen carbonate/citric acid as effervescents;
disintegrators, such as cellulose, carboxymethyl cellulose or cross-linked poly(N-vinyl-pyrrolidone);
rapidly dissolving materials, such as sodium (potassium) acetates, or sodium (potassium) citrates;
rapidly dissolving, water-soluble, rigid coating agents, such as dicarboxylic acids.

The tabs may also comprise combinations of such dissolution aids.

The detergent formulation may also be in the form of an aqueous liquid containing from 5 to 50 wt-%, preferably from 10 to 35 wt-%, of water or in the form of a non-aqueous liquid containing no more than 5 wt-%, preferably from 0 to 1 wt-%, of water. Non-aqueous liquid detergent formulations may comprise other solvents as carriers. Low molecular weight primary or secondary alcohols, for example methanol, ethanol, propanol and isopropanol, are suitable for that purpose. The solubilising surfactant used is preferably a monohydroxy alcohol but polyols, such as those containing from 2 to 6 carbon atoms and from 2 to 6 hydroxy groups (e.g., 1,3-propanediol, ethylene glycol, glycerol and 1,2-propanediol) can also be used. Such carriers are usually used in a total amount of from 5% to 90% by weight, preferably from 10 wt-% to 50 wt-%, based on the total weight of the detergent formulation. The detergent formulations can also used in so-called “unit liquid dose” form.

The invention relates also to granules that comprise the catalysts according to the invention and are suitable for incorporation into a powder-form or granular detergent, cleaning or bleaching composition. Such granules preferably comprise:
a) from 1 to 99 wt-%, preferably from 1 to 40 wt-%, especially from 1 to 30 wt-%, of at least one metal complex compound of formula (1) and at least one organic peroxy acid and/or at least one precursor of an organic peroxy acid and H₂O₂ in the form of an inorganic persalt as described above,
b) from 1 to 99 wt-%, preferably from 10 to 99 wt-%, especially from 20 to 80 wt-%, of at least one binder,
c) from 0 to 20 wt-%, especially from 1 to 20 wt-%, of at least one encapsulating material,
d) from 0 to 20 wt-% of at least one further additive and
e) from 0 to 20 wt-% water.

For metal complex compound of formula (1) and the organic peroxy acid and/or at least one precursor of an organic peroxy acid and the precursors of H₂O₂ in the form of an inorganic persalt as described above [component a)] all preferences as defined above apply for the granule.

As binder (b) there come into consideration water-soluble, dispersible or water-emulsifiable anionic dispersants, non-ionic dispersants, polymers and waxes.

The anionic dispersants used are, for example, commercially available water-soluble anionic dispersants for dyes, pigments etc.

The following products, especially, come into consideration: condensation products of aromatic sulfonic acids and formaldehyde, condensation products of aromatic sulfonic acids with unsubstituted or chlorinated diphenyls or diphenyl oxides and optionally formaldehyde, (mono-/di-)alkylnaphthalenesulfonates, sodium salts of polymerised organic sulfonic acids, sodium salts of polymerised alkylnaphthalenesulfonic acids, sodium salts of polymerised alkylbenzenesulfonic acids, alkylarylsulfonates, sodium salts of alkyl polyglycol ether sulfates, polyalkylated polynuclear arylsulfonates, methylene-linked condensation products of arylsulfonic acids and hydroxyarylsulfonic acids, sodium salts of dialkylsulfosuccinic acid, sodium salts of alkyl diglycol ether sulfates, sodium salts of polynaphthalenemethane-sulfonates, lignosulfonates or oxylignosulfonates and heterocyclic polysulfonic acids.

Especially suitable anionic dispersants are condensation products of naphthalenesulfonic acids with formaldehyde, sodium salts of polymerised organic sulfonic acids, (mono-/di-)-alkylnaphthalenesulfonates, polyalkylated polynuclear arylsulfonates, sodium salts of polymerised alkylbenzenesulfonic acid, lignosulfonates, oxylignosulfonates and condensation products of naphthalenesulfonic acid with a polychloromethyldiphenyl.

Suitable non-ionic dispersants are especially compounds having a melting point of, preferably, at least 35° C. that are emulsifiable, dispersible or soluble in water, for example the following compounds:
1. fatty alcohols having from 8 to 22 carbon atoms, especially cetyl alcohol;
2. addition products of, preferably, from 2 to 80 mol of alkylene oxide, especially ethylene oxide, wherein some of the ethylene oxide units may have been replaced by substituted epoxides, such as styrene oxide and/or propylene oxide, with higher unsaturated or saturated monoalcohols, fatty acids, fatty amines or fatty amides having from 8 to 22 carbon atoms or with benzyl alcohols, phenyl phenols, benzyl phenols or alkyl phenols, the alkyl radicals of which have at least 4 carbon atoms;
3. alkylene oxide, especially propylene oxide, condensation products (block polymers);
4. ethylene oxide/propylene oxide adducts with diamines, especially ethylenediamine;
5. reaction products of a fatty acid having from 8 to 22 carbon atoms and a primary or secondary amine having at least one hydroxy-lower alkyl or lower alkoxy-lower alkyl group, or alkylene oxide addition products of such hydroxyalkyl-group-containing reaction products;
6. sorbitan esters, preferably having long-chain ester groups, or ethoxylated sorbitan esters, such as polyoxyethylene sorbitan monolaurate having from 4 to 10 ethylene oxide units or polyoxyethylene sorbitan trioleate having from 4 to 20 ethylene oxide units;
7. addition products of propylene oxide with a tri- to hexa-hydric aliphatic alcohol having from 3 to 6 carbon atoms, e.g. glycerol or pentaerythritol; and
8. fatty alcohol polyglycol mixed ethers, especially addition products of from 3 to 30 mol of ethylene oxide and from 3 to 30 mol of propylene oxide with aliphatic monoalcohols having from 8 to 22 carbon atoms.

Especially suitable non-ionic dispersants are surfactants of formula

R₄₆—O-(alkylene-O)ₙ—R₄₇ (7),

wherein
R₄₆ is C₈-C₂₂alkyl or C₈-C₁₈alkenyl;
R₄₇ is hydrogen; C₁-C₄alkyl; a cycloaliphatic radical having at least 6 carbon atoms; or benzyl;

“alkylene” is an alkylene radical having from 2 to 4 carbon atoms and

n is a number from 1 to 60.

The substituents R₄₆ and R₄₇ in formula (7) are advantageously each the hydrocarbon radical of an unsaturated or, preferably, saturated aliphatic monoalcohol having from 8 to 22 carbon atoms. The hydrocarbon radical may be straight-chain or branched. R₄₆ and R₄₇ are preferably each independently of the other an alkyl radical having from 9 to 14 carbon atoms.

Aliphatic saturated monoalcohols that come into consideration include natural alcohols, e.g. lauryl alcohol, myristyl alcohol, cetyl alcohol or stearyl alcohol, and also synthetic alcohols, e.g. 2-ethylhexanol, 1,1,3,3-tetramethylbutanol, octan-2-ol, isononyl alcohol, trimethylhexanol, trimethylnonyl alcohol, decanol, C₉-C₁₁ oxo-alcohol, tridecyl alcohol, isotridecyl alcohol and linear primary alcohols (Alfols) having from 8 to 22 carbon atoms. Some examples of such Alfols are Alfol (8-10), Alfol (9-11), Alfol (10-14), Alfol (12-13) and Alfol (16-18). (“Alfol” is a registered trade mark of the company Sasol Limited).

Unsaturated aliphatic monoalcohols are, for example, dodecenyl alcohol, hexadecenyl alcohol and oleyl alcohol.

The alcohol radicals may be present singly or in the form of mixtures of two or more components, e.g. mixtures of alkyl and/or alkenyl groups that are derived from soybean fatty acids, palm kernel fatty acids or tallow oils.

(Alkylene-O) chains are preferably bivalent radicals of the formulae

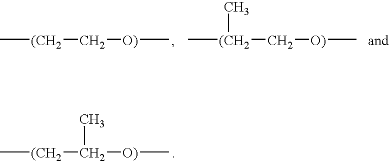

Examples of a cycloaliphatic radical include cycloheptyl, cyclooctyl and preferably cyclohexyl.

As non-ionic dispersants there come into consideration preferably surfactants of formula

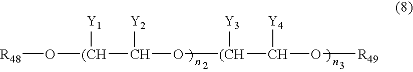

wherein

R₄₈ is C₈-C₂₂alkyl,

R₄₉ is hydrogen or C₁-C₄alkyl,

Y₁, Y₂, Y₃ and Y₄ are each independently of the others hydrogen; methyl or ethyl,

n₂ is a number from 0 to 8; and

n₃ is a number from 2 to 40.

Further important non-ionic dispersants correspond to formula

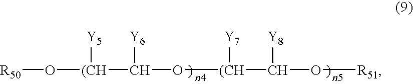

wherein

R₅₀ is C₉-C₁₄alkyl,

R₅₁ s C₁-C₄alkyl,

Y₅, Y₆, Y₇ and Y₈ are each independently of the others hydrogen, methyl or ethyl, one of the radicals Y₅, Y₆ and one of the radicals Y₇, Y₈ always being hydrogen; and

n₄ and n₅ are each independently of the other an integer from 4 to 8.

The non-ionic dispersants of formulae (7) to (9) can be used in the form of mixtures. For example, as surfactant mixtures there come into consideration non-end-group-terminated fatty alcohol ethoxylates of formula (7), e.g. compounds of formula (7) wherein

R₄₆ is C₈-C₂₂alkyl,

R₄₇ is hydrogen and

the alkylene-O chain is the radical —(CH₂CH₂O)—
and also end-group-terminated fatty alcohol ethoxylates of formula (9).

Examples of non-ionic dispersants of formulae (7), (8) and (9) include reaction products of a C₁₀-C₁₃fatty alcohol, e.g. a C₁₃oxo-alcohol, with from 3 to 10 mol of ethylene oxide, propylene oxide and/or butylene oxide and the reaction product of one mol of a C₁₃fatty alcohol with 6 mol of ethylene oxide and 1 mol of butylene oxide, it being possible for the addition products each to be end-group-terminated with C₁-C₄alkyl, preferably methyl or butyl.

Such dispersants can be used singly or in the form of mixtures of two or more dispersants. Instead of, or in addition to, the anionic or non-ionic dispersant, the granules according to the invention may comprise a water-soluble organic polymer as binder. Such polymers may be used singly or in the form of mixtures of two or more polymers.

Water-soluble polymers that come into consideration are, for example, polyethylene glycols, copolymers of ethylene oxide with propylene oxide, gelatin, polyacrylates, polymethacrylates, polyvinylpyrrolidones, vinylpyrrolidones, vinyl acetates, polyvinylimidazoles, polyvinylpyridine-N-oxides, copolymers of vinylpyrrolidone with long-chain Oolefins, copolymers of vinylpyrrolidone with vinylimidazole, poly(vinylpyrrolidoneldimethylaminoethyl methacrylates), copolymers of vinylpyrrolidone/dimethylaminopropyl methacrylamides, copolymers of vinylpyrrolidone/dimethylaminopropyl acrylamides, quaternised copolymers of vinylpyrrolidones and dimethylaminoethyl methacrylates, terpolymers of vinylcaprolactam/vinylpyrrolidoneldimethylaminoethyl methacrylates, copolymers of vinylpyrrolidone and methacrylamidopropyl-trimethylammonium chloride, terpolymers of caprolactamtvinylpyrrolidone/dimethylaminoethyl methacrylates, copolymers of styrene and acrylic acid, polycarboxylic acids, polyacrylamides, carboxymethyl cellulose, hydroxymethyl cellulose, polyvinyl alcohols, polyvinyl acetate, hydrolysed polyvinyl acetate, copolymers of ethyl acrylate with methacrylate and methacrylic acid, copolymers of maleic acid with unsaturated hydrocarbons, and also mixed polymerisation products of the mentioned polymers.

Of those organic polymers, special preference is given to polyethylene glycols, carboxymethyl cellulose, polyacrylamides, polyvinyl alcohols, polyvinylpyrrolidones, gelatin, hydrolysed polyvinyl acetates, copolymers of vinylpyrrolidone and vinyl acetate, and also polyacrylates, copolymers of ethyl acrylate with methacrylate and methacrylic acid, and polymethacrylates.

Suitable water-emulsifiable or water-dispersible binders also include paraffin waxes.

Encapsulating materials (c) include especially water-soluble and water-dispersible polymers and waxes. Of those materials, preference is given to polyethylene glycols, polyamides, polyacrylamides, polyvinyl alcohols, polyvinylpyrrolidones, gelatin, hydrolysed polyvinyl acetates, copolymers of vinylpyrrolidone and vinyl acetate, and also polyacrylates, paraffins, fatty acids, copolymers of ethyl acrylate with methacrylate and methacrylic acid, and polymethacrylates.

Further additives (d) that come into consideration are, for example, wetting agents, dust removers, water-insoluble or water-soluble dyes or pigments, and also dissolution accel-erators, optical brighteners and sequestering agents.

The preparation of the granules according to the invention is carried out, for example, starting from:

a) a solution or suspension with a subsequent drying/shaping step or
b) a suspension of the active ingredient in a melt with subsequent shaping and solidification.
a) First of all the anionic or non-ionic dispersant and/or the polymer and, optionally, the further additives are dissolved in water and stirred, if desired with heating, until a homo-geneous solution is obtained. The catalyst according to the invention is then dissolved or suspended in the resulting aqueous solution. The solids content of the solution should preferably be at least 30 wt-%, especially from 40 to 50 wt-%, based on the total weight of the solution. The viscosity of the solution is preferably less than 200 mPa·s (at 20° C.).

The aqueous solution so prepared, comprising the catalyst according to the invention, is then subjected to a drying step in which all water, with the exception of a residual amount, is removed, solid particles (granules) being formed at the same time. Known methods are suitable for producing the granules from the aqueous solution. In principle, both continuous methods and discontinuous methods are suitable. Continuous methods are preferred, espe-cially spray-drying and fluidised bed granulation processes.

Especially suitable are spray-drying processes in which the active ingredient solution is sprayed into a chamber with circulating hot air. The atomisation of the solution is effected e.g. using unitary or binary nozzles or is brought about by the spinning effect of a rapidly rotating disc. In order to increase the particle size, the spray-drying process may be combined with an additional agglomeration of the liquid particles with solid nuclei in a fluidised bed that forms an integral part of the chamber (so-called fluid spray). The fine particles (<100 μm) obtained by a conventional spray-drying process may, if necessary after being separated from the exhaust gas flow, be fed as nuclei, without further treatment, directly into the atomizing cone of the atomiser of the spray-dryer for the purpose of agglomeration with the liquid droplets of the active ingredient.

During the granulation step, the water can rapidly be removed from the solutions comprising the catalyst according to the invention, binder and further additives. It is expressly intended that agglomeration of the droplets forming in the atomising cone, or agglomeration of droplets with solid particles, will take place.

If necessary, the granules formed in the spray-dryer are removed in a continuous process, for example by a sieving operation. The fines and the oversize particles are either recycled directly to the process (without being redissolved) or are dissolved in the liquid active ingredient formulation and subsequently granulated again.

A further preparation method according to a) is a process in which the polymer is mixed with water and then the catalyst is dissolved/suspended in the polymer solution, thus forming an aqueous phase, the catalyst according to the invention being homogeneously distributed in that phase. At the same time or subsequently, the aqueous phase is dispersed in a water-immiscible liquid in the presence of a dispersion stabiliser in order that a stable dispersion is formed. The water is then removed from the dispersion by distillation, forming substantially dry particles. In those particles, the catalyst is homogeneously distributed in the polymer matrix.

The granules according to the invention are resistant to abrasion, low in dust, pourable and readily meterable. They can be added directly to a formulation, such as a detergent formulation, in the desired concentration of the catalyst according to the invention.

Where the coloured appearance of the granules in the detergent is to be suppressed, this can be achieved, for example, by embedding the granules in a droplet of a whitish meltable substance (“water-soluble wax”) or by adding a white pigment (e.g. Ti02) to the granule formulation or, preferably, by encapsulating the granules in a melt consisting, for example, of a water-soluble wax, as described in EP-A-0 323 407, a white solid being added to the melt in order to reinforce the masking effect of the capsule.

b) The catalyst according to the invention is dried in a separate step prior to the melt-granulation and, if necessary, dry-ground in a mill so that all the solids particles are <50 μm in size. The drying is carried out in an apparatus customary for the purpose, for example in a paddle dryer, vacuum cabinet or freeze-dryer.

The finely particulate catalyst is suspended in the molten carrier material and homogenised. The desired granules are produced from the suspension in a shaping step with simultaneous solidification of the melt. The choice of a suitable melt-granulation process is made in accordance with the desired size of granules. In principle, any process which can be used to produce granules in a particle size of from 0.1 to 4 mm is suitable. Such processes are droplet processes (with solidification on a cooling belt or during free fall in cold air), melt-prilling (cooling medium gas/liquid), and flake formation with a subsequent commination step, the granulation apparatus being operated continuously or discontinuously.

Where the coloured appearance of the granules prepared from a melt is to be suppressed in the detergent, in addition to the catalyst it is also possible to suspend in the melt white or coloured pigments which, after solidification, impart the desired coloured appearance to the granules (e.g. titanium dioxide).

If desired, the granules can be covered with or encapsulated in an encapsulating material. Methods that come into consideration for such an encapsulation include the customary methods and also encapsulation of the granules by a melt consisting e.g. of a water-soluble wax, as described, for example, in EP-A-0 323 407, coacervation, complex coacervation and surface polymerisation.

Encapsulating materials (c) include e.g. water-soluble, water-dispersible or water-emulsifiable polymers and waxes.

As further additives (d) there come into consideration, for example, wetting agents, dust removers, water-insoluble or water-soluble dyes or pigments, and also dissolution accelerators, optical brighteners and sequestering agents.

Other product forms of the present invention include product forms specifically developed for industrial and institutional cleaning, for example liquid solutions of the catalyst in water or organic solvents or solid forms such as powders or granules which can be dosed in a separate bleaching step of the cleaning application.

Surprisingly, the metal complex compounds of formula (1) also exhibit a markedly improved bleach-catalysing action on coloured stains occurring on kitchen surfaces, wall tiles or floor tiles.

The use of at least one metal complex compound of formula (1) as catalyst(s) in cleaning solutions for hard surfaces, especially for kitchen surfaces, wall tiles or floor tiles, or in (automatic) dishwasher formulations is therefore of special interest.

The metal complex compounds of formula (1) and the corresponding ligands also have excellent antibacterial action. The use thereof for killing bacteria or for protecting against bacterial attack is therefore likewise of interest.

The metal complex compounds of formula (1) are also outstandingly suitable for selective oxidation in the context of organic synthesis, especially the oxidation of organic molecules, e.g. of olefins to form epoxides. Such selective transformation reactions are required especially in process chemistry.

The following Examples serve to illustrate the invention but do not limit the invention thereto. Parts and percentages relate to weight, unless otherwise indicated. Temperatures are in degrees Celsius, unless otherwise indicated.

### EXAMPLES

### Synthesis of 4′-Substituted Terpyridines and 4-Pyridones

### Example 1

### 1′H-[2,2′;6′,2′]Terpyridin-4′-one (Hereinafter Called L1)

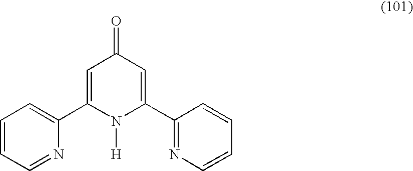

The synthesis of this compound is done in analogy of Example 1 (page 26) of WO 02/088289.

### Example 2

### 4′-Chloro-[2,2′;6′,2″]terpyridine (Hereinafter Called L2)

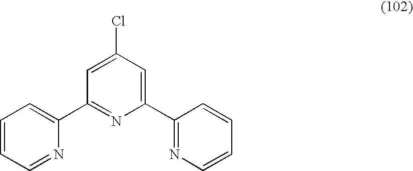

The synthesis of this compound is done in analogy of Example 2 (page 27) of WO 02/088289.

### Example 3

### 4′-Ethoxy-[2,2′;6′,2″]terpyridine (Hereinafter Called L3)

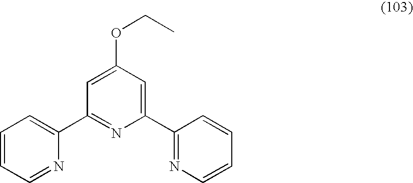

The synthesis of this compound is done in analogy of Example 3 (page 28) of WO 02/088289.

### Example 4

### [2,2′;6′,2″]Terpyrid-4′-yl-hydrazine (Hereinafter Called L4)

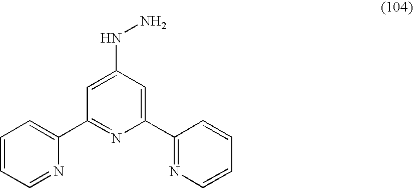

The synthesis of this compound is done in analogy of Example 4 (page 28) of WO 02/088289.

### Example 5

### 2-(Methyl-[2,2′;6′,2″]terpyrid-4′-yl-amino)-ethanol (Hereinafter Called L5)

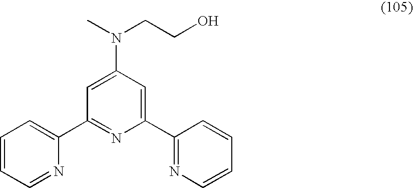

The synthesis of this compound is done in analogy of Example 5 (page 29) of WO 02/088289.

### Example 6

### 4′-Pyrrolidin-1-yl-[2,2′;6′,2″]terpyridine (Hereinafter Called L6)

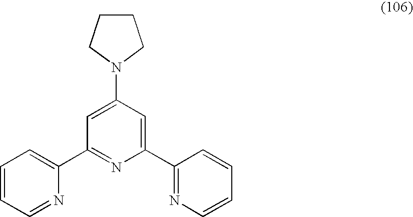

The synthesis of this compound is done in analogy of Example 6 (page 29) of WO 02/088289.

### Example 7

### 2-[(2-Hydroxy-ethyl)-[2,2′;6′,2″]terpyrid-4′-yl-amino]-ethanol (Hereinafter Called L7)

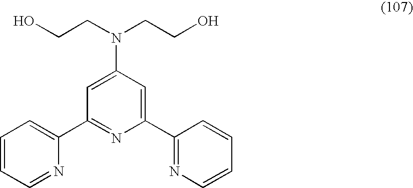

The synthesis of this compound is done in analogy of Example 7 (page 30) of WO 02/088289.

### Example 8

### 4′-(4-Methyl-piperazin-1-yl)-[2,2′;6′,2″]terpyridine (Hereinafter Called L8)

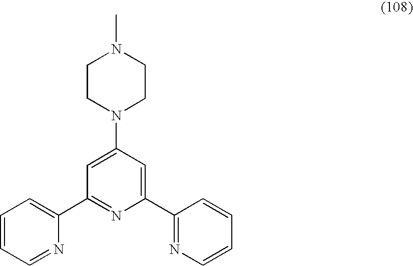

The synthesis of this compound is done in analogy of Example 8 (page 31) of WO 02/088289.

### Example 8b

### 1,1-Dimethyl-4-[2,2′;6′,2″]terpyrid-4′-yl-piperazin-1-ium iodide (Hereinafter Called L8b)

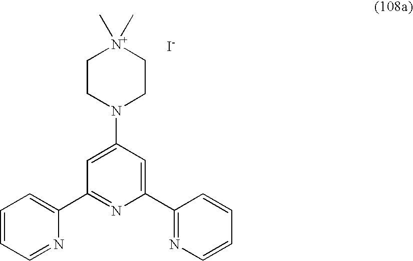

The synthesis of this compound is done in analogy of Example 8b (page 31) of WO 02/088289.

### Example 9

### 4′-Azepan-1-yl-[2,2′;6′,2″]terpyridine (Hereinafter Called L9)

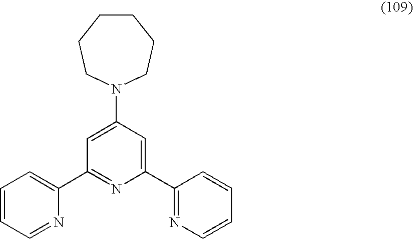

The synthesis of this compound is done in analogy of Example 9 (page 32) of WO 02/088289.

### Example 10

### 4′-Piperidin-1-yl-[2,2′;6′,2″]terpyridine (Hereinafter Called L10)

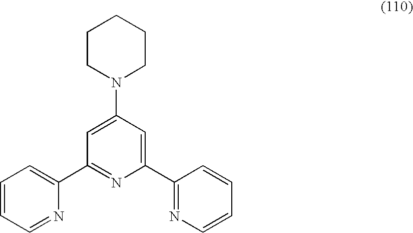

The synthesis of this compound is done in analogy of Example 10 (page 32) of WO 02/088289.

### Example 11

### 4′-Morpholin-4-yl-[2,2′;6′,2″]terpyridine (Hereinafter Called L11)

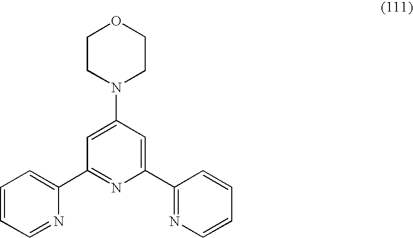

The synthesis of this compound is done in analogy of Example 11 (page 33) of WO 02/088289.

### Example 12

### 4′-(4-tert-Butyl-phenyl)-[2,2′;6′,2″]terpyridine (Hereinafter Called L12)

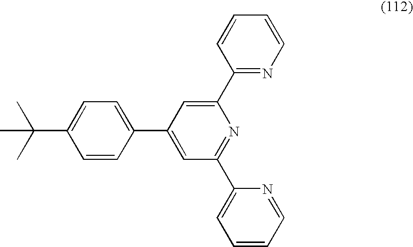

The synthesis of this compound is done in analogy of Example 12 (page 33) of WO 02/088289.

### Example 13

### 4′-(4-Isopropyl-phenyl)-[2,2′;6′,2″]terpyridine (Hereinafter Called L13)

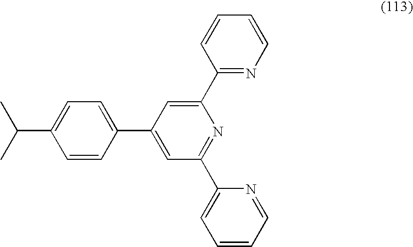

The synthesis of this compound is done in analogy of Example 13 (page 34) of WO 02/088289.

### Example 14

### 4′-p-Tolyl-[2,2′;6′,2″]terpyridine (Hereinafter Called L 14)

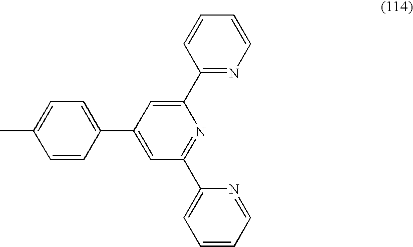

The synthesis of this compound is done in analogy of Example 14 (page 34) of WO 02/088289.

### Example 15

### 4′-Biphenyl-4-yl-[2,2′;6′,2″]terpyridine (Hereinafter Called L15)

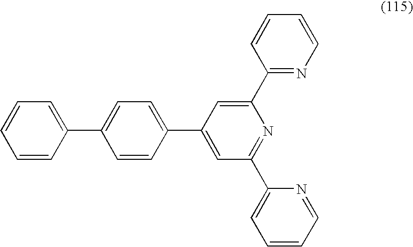

The synthesis of this compound is done in analogy of Example 15 (page 35) of WO 02/088289.

### Synthesis of Building Blocks for Polysubstituted Ligands of the Pyridone Type

### Example 16

### 4-Chloro-pyridine-2-carboxylic Acid Methyl Ester

The synthesis of this compound is done in analogy of Example 16 (page 35) of WO 02/088289.

### Example 17

### 4-Chloro-pyridine-2-carboxylic Acid Ethyl Ester

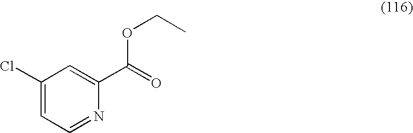

### a) Step 1:

10.0 ml (0.130 mol) of N,N-dimethylformamide are added dropwise to 295 ml of (4.06 mol) of thionyl chloride at 40° C. with stirring. 100 g (0.812 mol) of picolinic acid are then added in the course of half an hour. The mixture is cautiously heated to 70° C. and stirred at that temperature for 24 hours, the gases formed being conveyed away through a wash bottle charged with sodium hydroxide solution. Concentration and co-evaporation a further three times with 100 ml of toluene each time are carried out, the residue is diluted with that solvent to 440 ml, and the solution is introduced into a mixture of 120 ml of absolute ethanol and 120 ml of toluene. The mixture is concentrated to approximately half its volume, cooled to 4° C., filtered with suction and washed with toluene. 4-chloro-pyridine-2-carboxylic acid ethyl ester hydrochloride is obtained in the form of a beige, hygroscopic powder.

### b) Step 2:

The hydrochloride obtained in Step 1 is taken up in 300 ml of ethyl acetate and 200 ml of deionised water and rendered neutral with 4N sodium hydroxide solution. After separation of the phases, extraction is carried out twice using 200 ml of ethyl acetate each time. The organic phases are combined, dried over sodium sulfate, filtered and concentrated. 4-Chloro-pyridine-2-carboxylic acid ethyl ester is obtained in the form of a brown oil which, if required, can be purified by distillation.

¹H-NMR (360 MHz, CDCl₃): 8.56 (d, 1H, J=5.0 Hz); 8.03 (d, 1H, J=1.8 Hz); 7.39 (dd, 1H, J=5.4, 1.8 Hz); 4.39 (q, 2H, J=7.0 Hz); 1.35 (t, 3H, J=7.0 Hz).

### Example 18

### 4-Ethoxy-pyridine-2-carboxylic Acid Ethyl Ester

The synthesis of this compound is done in analogy of Example 17 (page 36) of WO 02/088289.

### Example 19

### 4-Pyrrolidin-1-yl-pyridine-2-carboxylic Acid Ethyl Ester

The synthesis of this compound is done in analogy of Example 18 (page 36) of WO 02/088289.

### Example 20

### 1,5-Bis(4-chloropyrid-2-yl)-pentane-1,3,5-trione

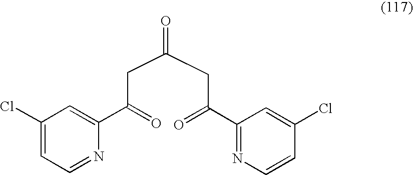

The synthesis of this compound is done in analogy of Example 19 (page 37) of WO 02/088289.

### Example 21

### 1,5-Bis(4-ethoxy-pyrid-2-yl)-pentane-1,3,5-trione

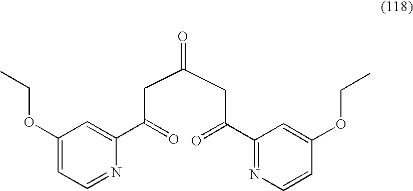

The synthesis of this compound is done in analogy of Example 20 (page 37) of WO 02/088289.

### Example 22

### 1,5-Bis(4-pyrrolidin-1-yl-pyrid-2-yl)-pentane-1,3,5-trione

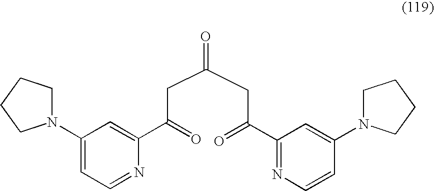

The synthesis of this compound is done in analogy of Example 21 (page 37) of WO 02/088289.

### Example 23

### 1-Pyrid-2-yl-butane-1,3-dione

Under argon, a solution of 8.71 g (150 mmol) of dry acetone in 100 ml of absolute tetrahydrofuran is added to a solution of 20.42 g (300 mmol) of sodium ethanolate in 300 ml of absolute tetrahydrofuran. A solution of 22.68 g (150 mmol) of pyridine-2-carboxylic acid ethyl ester in 100 ml of absolute tetrahydrofuran is then added dropwise in the course of 20 minutes. The mixture is stirred for 15 hours at room temperature and for four hours at boiling temperature. Concentration is carried out using a rotary evaporator, 150 ml of water are added, and the mixture is rendered neutral by glacial acetic acid. Extraction is carried out twice with diethyl ether, and the organic extracts are combined and dried (sodium sulfate), yielding 1-pyrid-2-yl-butane-1,3-dione in the form of an orange oil after concentration using a rotary evaporator.

¹H-NMR (360 MHz, CDCl₃) for enol tautomer 15.8-15.5 (br s, OH); 8.60-8.55 (dm, 1H); 8.20-7.95 (dm, 1H); 7.79-7.71 (tm, 1H); 7.35-7.29 (m, 1H); 6.74 (s, 1H); 2.15 (s, 3H). Keto tautomer CH₂— group at 4.20 ppm (enol/keto form ratio=87:13).

### Example 24

### 1-(4-Chloro-pyrid-2-yl)-5-pyrid-2-yl-pentane-1,3,5-trione

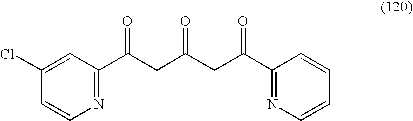

At boiling temperature, a mixture of 21.3 g (131 mmol) of 1-pyrid-2-yl-butane-1,3-dione and 36.3 g (196 mmol) of 4-chloro-pyridine-2-carboxylic acid ethyl ester in 100 ml of absolute tetrahydrofuran is added dropwise in the course of two hours to 10.43 g (261 mmol, approx. 60% dispersion) of sodium hydride in 200 ml of absolute tetrahydrofuran. The mixture is then stirred for a further 2 hours at 70° C. and concentrated using a rotary evaporator and then, at 4° C., 200 ml of water are cautiously added. The mixture is rendered neutral with 5N hydro-chloric acid, and 1-(4-chloro-pyrid-2-yl)-5-pyrid-2-yl-pentane-1,3,5-trione is filtered off in the form of a yellowish-green solid. The dried, sparingly soluble product is further processed without special purification steps.

### Synthesis of Polysubstituted Terpyridines and Pyridones

### Example 25

### 4,4″-Dichloro-1′H-[2,2′;6′,2″]terpyridin-4′-one (Hereinafter Called L16)

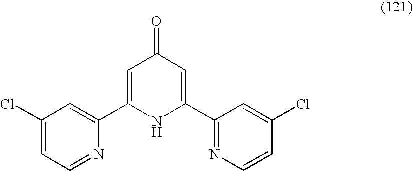

The synthesis of this compound is done in analogy of Example 22 (page 38) of WO 02/088289.

### Example 26

### 4,4″-Diethoxy-1′H-[2,2′;6′,2″]terpyridin-4′-one (Hereinafter Called L17)

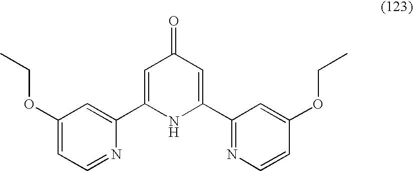

The synthesis of this compound is done in analogy of Example 23 (page 38) of WO 02/088289.

### Example 27

### 4,4″-Di-pyrrolidin-1-yl-1′H-[2,2′;6′,2″]terpyridin-4′-one (Hereinafter Called L18)

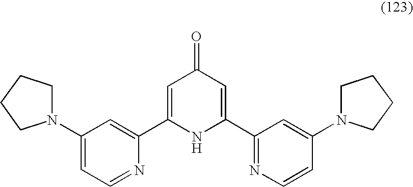

The synthesis of this compound is done in analogy of Example 24 (page 39) of WO 02/088289.

### Example 28

### 4,4″-Bis[(2-hydroxy-ethyl)-methyl-amino]-1′H-[2,2′;6′,2″]terpyridin-4′-one (Hereinafter Called L19)

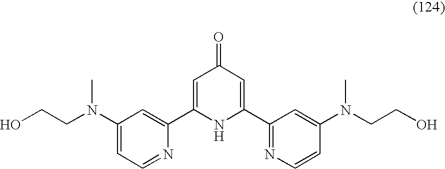

The synthesis of this compound is done in analogy of Example 25 (page 39) of WO 02/088289.

### Example 29

### 4,4′-Diethoxy-4′-methoxy-[2,2′;6′,2″]terpyridine (Hereinafter Called L20)

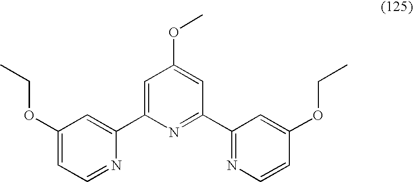

The synthesis of this compound is done in analogy of Example 26 (page 40) of WO 02/088289.

### Example 30

### 4′-Methoxy-4,4″-di-pyrrolidin-1-yl-[2,2′;6′,2″]terpyridine (Hereinafter Called L21)

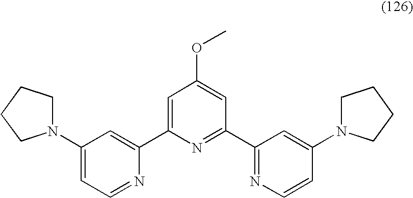

The synthesis of this compound is done in analogy of Example 27 (page 40) of WO 02/088289.

### Example 31

### 4,4′,4″-Trichloro-[2,2′;6′,2″]terpyridine (hereinafter called 1-22)

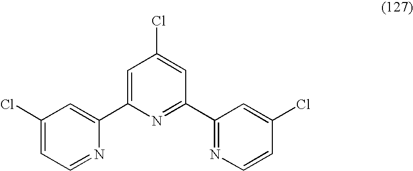

The synthesis of this compound is done in analogy of Example 28 (page 41) of WO 02/088289.

### Example 32

### 4,4′,4″-Triethoxy-[2,2′;6′,2″]terpyridine (Hereinafter Called L23)

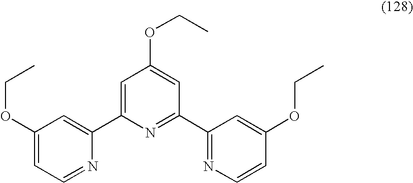

The synthesis of this compound is done in analogy of Example 29 (page 41) of WO 02/088289.

### Example 33

### 4,4′,4″-Tri-pyrrolidin-1-yl-[2,2′;6′,2″]terpyridine (Hereinafter Called L24)

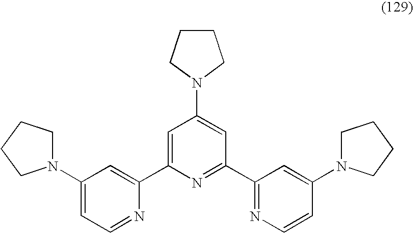

The synthesis of this compound is done in analogy of Example 30 (page 42) of WO 02/088289.

### Example 34

### 2-({4′,4″-Bis[(2-hydroxy-ethyl)-methyl-amino]-[2,2′;6′,2″]terpyridin-4-yl}-methyl-amino)ethanol (Hereinafter Called L25)

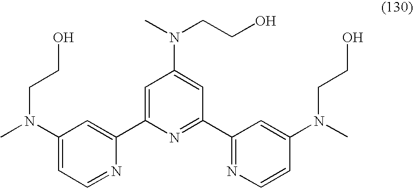

The synthesis of this compound is done in analogy of Example 31 (page 42) of WO 02/088289.

### Example 35

### 4′-Chloro-4,4″-diethoxy-[2,2′;6′,2″]terpyridine (Hereinafter Called L26)

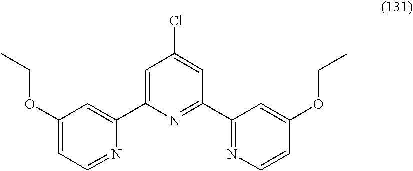

The synthesis of this compound is done in analogy of Example 32 (page 43) of WO 02/088289.

### Example 36

### 4,4″-Diethoxy-4′-pyrrolidin-1-yl-[2,2′;6′,2″]terpyridine (Hereinafter Called L27)

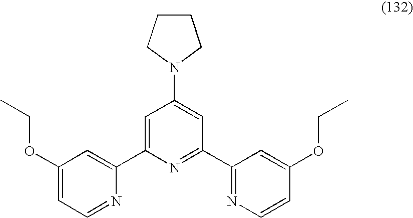

The synthesis of this compound is done in analogy of Example 33 (page 43) of WO 02/088289.

### Example 37

### 2-[(4,4″-Diethoxy-[2,2′;6′,2″]terpyrid-4′-yl)-(2-hydroxy-ethyl)-amino]-ethanol (Hereinafter Called L28)

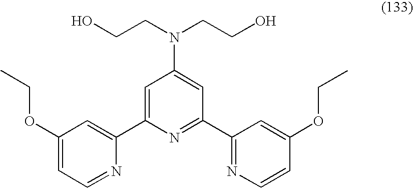

The synthesis of this compound is done in analogy of Example 34 (page 44) of WO 02/088289.

### Example 38

### 6,6″-Bis(2-methoxyphenyl)-2,2′:6′:2″-terpyridine (Hereinafter Called L29)

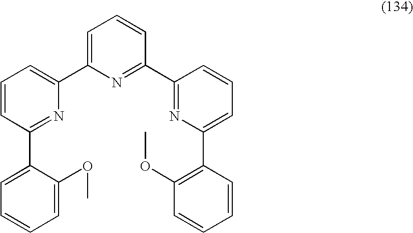

The synthesis of this compound is done in analogy of Example 35 (page 44) of WO 02/088289.

### Example 39

### 6,6″-Bis(2-hydroxyphenyl)-2,2′:6′,2″-terpyridine (Hereinafter Called L30)

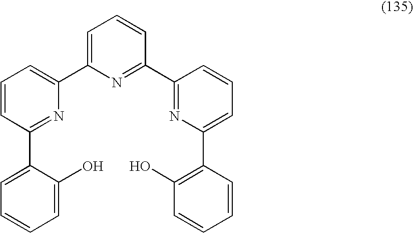

The synthesis of this compound is done in analogy of Example 36 (page 45) of WO 02/088289.

### Example 40

### 4-Chloro-1′H-[2,2′;6′,2″]terpyridin-4′-one (Hereinafter Called L31)

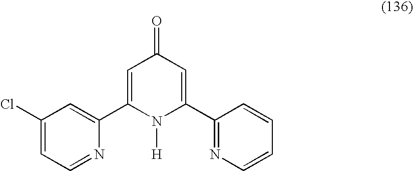

110 ml of 25% ammonium hydroxide solution are added to 1-(4-chloro-pyrid-2-yl)-5-pyrid-2-yl-pentane-1,3,5-trione (for preparation see Example 24) in 100 ml of isopropanol and refluxed for 4.5 hours. At room temperature, the mixture is adjusted to pH 5 using 6N hydrochloric acid and filtered. The residue is filtered over silica gel (eluant chloro-form/methanol/ammonium hydroxide solution 4:1:0.1), filtered and concentrated. After recrystallisation from acetone, 4-chloro-1′H-[2,2′;6′,2″]terpyridin-4′-one is obtained in the form of a grey solid, which is further processed without special purification steps.

¹H-NMR (360 MHz, DMSO-d): 8.72-8.63 (m, 2H); 8.62-8.53 (m, 2H); 7.98 (ddd, 1H, J=7.7, 7.7, 1.8 Hz); 7.87 (d, 1H, J=2.2 Hz); 7.83 (d, 1H, J=2.2 Hz); 7.59 (dd, 1H, J=5.4, 2.2 Hz); 7.43-7.51 (m, 1H); 2.07 (s, 1H).

### Example 41

### 4-(4-Methyl-piperazin-1-yl)-1′H-[2,2′;6′,2″]terpyridin-4′-one (Hereinafter Called L32)

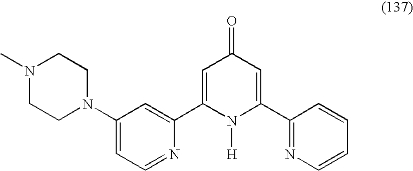

A mixture of 5.22 g (18.4 mmol) of 4-chloro-1′H-[2,2′;6′,2″]terpyridin-4′-one (L31 in Example 40), 18.36 g (184 mmol, 20.4 ml) of 1-methyl-piperazine and 125 mg (0.92 mmol, 0.05 equivalent) of zinc(II) chloride in 80 ml of 2-methyl-2-butanol is refluxed for 30 hours and concentrated to dryness using a rotary evaporator. 100 ml of water are added and the mixture is rendered neutral using concentrated hydrochloric acid. After extraction four times with chloroform, and combining and drying (sodium sulfate) the organic extracts, the crude product is obtained, which is then recrystallised from acetonitrile. 4-(4-Methyl-piperazin-1-yl)-1′H-[2,2′;6′,2″]terpyridin-4′-one is obtained in the form of a white solid.

¹H-NMR (360 MHz, CDCl₃): 8.69 (d, 1H, 4.5 Hz); 8.32 (d, 1H, J=5.9 Hz); 7.92-7.74 (m, 2H); 7.37-7.30 (m, 1H); 7.20 (d, 1H, J=2.3 Hz); 7.01 (s, 1H); 6.98 (s, 1H); 6.71-6.63 (m, 1H); 3.45-3.35 (tm, 4H); 2.58-2.48 (tm, 4H); 2.32 (s, 3H).

### Example 42

### 1,1-Dimethyl-4-(4′-oxo-1′,4′-dihydro-[2,2′;6′,2″]terpyrid-4-yl)-piperazin-1-ium Methosulfate ((Hereinafter Called L33))

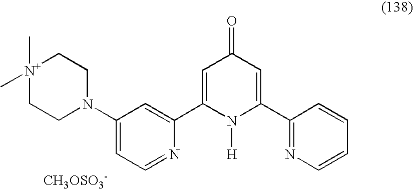

0.33 ml (3.5 mmol, 442 mg) of dimethyl sulfate is added dropwise to a suspension of 1.22 g (3.5 mmol) of 4-(4-methyl-piperazin-1-yl)-1′H-[2,2′;6′,2″]terpyridin-4′-one (L32 in Example 41) in 60 ml of acetone. After 17 hours, filtration is carried out and the crude product is washed (acetone and dichloromethane) and then recrystallised from methanol. 1,1-Dimethyl-4-(4′-oxo-1′,4′-dihydro-[2,2′;6′,2″]terpyrid-4-yl)piperazin-1-ium methosulfate is obtained in the form of a white solid. C₂₂H₂₇N₅O₅S*0.09H₂O, 475.17; calculated C, 55.61; H, 5.77; N, 14.74; S, 6.75; H₂O, 0.34. found C, 55.56; H, 5.85; N, 14.63; S, 6.75; H₂O, 0.33.

¹H-NMR (360 MHz, D₂O): 8.31 (d, 1H, J=4.1 Hz); 7.76 (dd, 1H, J=7.7); 7.64 (d, 1H, J=7.7 Hz); 7.58 (d, 1H, J=5.4 Hz); 7.22 (dd, 1H, J=7.2, 5.0 Hz), 6.71 (s, 1H, 6.48 (dm, 1H); 6.46-6.39 (dm, 1H); 6.34 (dm, 1H); 3.67 (s, 3H); 3.48 (br s, 8H); 3.19 (s, 6H).

### Example 43

### 4,4″-Bis(4-methyl-piperazin-1-yl)-1′H-[2,2′;6′,2″]terpyridin-4′-one (Hereinafter Called L34)

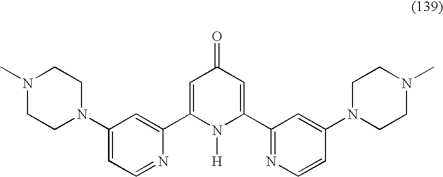

A mixture of 10.89 g (34.2 mmol) of 4,4″-dichloro-1′H-[2,2′;6′,2″]terpyridin-4′-one (L16 in Example 25), 68.6 g (685 mmol, 76.1 ml) of 1-methyl-piperazine and 233 mg (1.71 mmol, 0.05 equivalent) of zinc(II) chloride in 200 ml of 2-methyl-2-butanol is refluxed for 24 hours and concentrated to dryness using a rotary evaporator. The crude product is recrystallised from ethyl acetate/methanol 33:1 (v/v), taken up in 100 ml of water and adjusted to pH 8-9 using 4N sodium hydroxide, and light-beige 4,4″-bis(4-methyl-piperazin-1-yl)-1′H-[2,2′;6′,2″]terpyridin-4′-one is filtered off.

¹H-NMR (360 MHz, CDCl₃): 8.32 (d, 2H, J=5.9 Hz); 7.18 (dm, 2H); 6.93 (s, 2H); 6.66 (dd, 2H; J=5.9, 2.3 Hz); 3.41-3.32 (tm, 8H); 2.55-2.44 (tm, 8H); 2.29 (s, 6H).

### Example 44

### Twofold Quaternisation of 4,4″-bis(4-methyl-piperazin-1-yl)-1′H-[2,2′;6′,2″]terpyridin-4′-one with Methyl Iodide (Hereinafter Called L35)

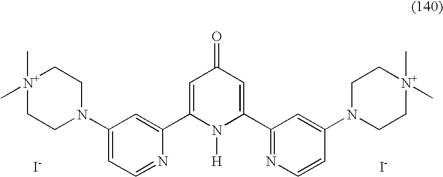

8.7 ml (19.9 g, 140 mmol) of methyl iodide are added dropwise to a suspension of 3.12 g (7 mmol) of 4,4″-bis(4-methyl-piperazin-1-yl)-1′H-[2,2′;6′,2″]terpyridin-4′-one (L34 in Example 43) in 150 ml of acetonitrile. Stirring for 5 hours at room temperature and filtration are carried out, and the resulting twofold-quaternised, whitish 4,4″-bis(4-methyl-piperazin-1-yl)-1′H-[2,2′;6′,2″]terpyridin-4′-one (C₂₇H₃₇I₂N₇O) is washed (acetonitrile).

¹H-NMR (360 MHz, D₂O): 7.73 (d, 2H, J=5.9 Hz); 6.88 (s, 2H); 6.63-6.54 (dm, 2H); 6.45 (s, 2H); 3.69-3.43 (dm, 16H); 3.20 (s, 12H).

### Example 44a

### Threefold Methylation of 4,4″-bis(4-methyl-piperazin-1-yl)-1′H-[2,2′;6′,2″]terpyridin-4′-one with Methyl Iodide (Ligand L35a)

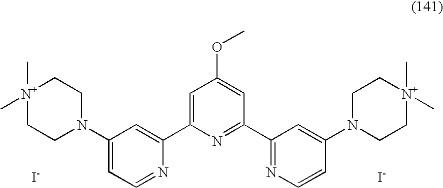

156 mg (0.35 mmol) of 4,4″-bis(4-methyl-piperazin-1-yl)-1′H-[2,2′;6′,2″]terpyridin-4′-one (L34 in Example 43) are added at 4° C. to a suspension of a total of approx. 30 mg of sodium hydride (approx 0.75 mmol, 60% in mineral oil) in 3 ml of absolute N,N-dimethylformamide. The mixture is stirred for 20 minutes at that temperature, heated at room temperature for one hour, and cooled again. 66 μl (1.05 mmol) of methyl iodide are then added dropwise, and the mixture is stirred for 20 minutes with cooling and for 30 minutes at room temperature. After cooling again and adding 2 ml of water, white, threefold-methylated 4,4″-bis(4-methyl-piperazin-1-yl)-1′H-[2,2′;6′,2″]terpyridin-4′-one of formula C28H₃₉I₂N₇O is filtered off.

¹³C-NMR (40 MHz, DMSO-d₆): 167.2; 156.8; 155.6; 154.7; 149.8; 109.4; 106.4; 105.6; 59.9; 55.5; 50.4; 40.0.

### Example 45

### Anion Exchange in L35 (Ligand L36)

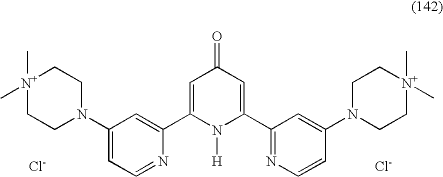

0.96 g (1.32 mmol) of 4,4″-bis(4-methyl-piperazin-1-yl)-1′H-[2,2′;6′,2″]terpyridin-4′-one, twofold-quaternised with methyl iodide, is dissolved in 10 ml of dilute HCl (pH=6). The solution is eluted through an ion exchange column (100 g of DOWEX 1×8, 200-400 mesh, chloride form) and concentrated using a rotary evaporator.

C₂₇H₃₇Cl₂N₇O*1.8HCl*2H₂O, calculated C, 50.03; H, 6.66; N, 15.13; Cl, 20.78. found C, 50.47; H, 6.67; N, 14.90; Cl, 20.4 (Iodine content<0.3).

¹H-NMR (400 MHz, D₂O): 8.17 (dm, 2H, J=7 Hz); 7.59 (s, 2H); 7.46 (s, 2H); 7.15 (dm, 2H, J=7 Hz); 4.14 (br s, 8H); 3.71 (br s, 8H); 3.30 (s, 12H).

### Example 46

### Twofold Quaternisation of 4,4″-bis(4-methyl-piperazin-1-yl)-1′H-[2,2′;6′,2″]terpyridin-4′-one with Dimethyl Sulfate (Ligand L37)

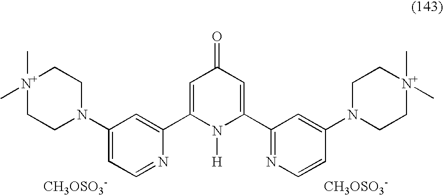

2.66 ml (27.92 mmol) of dimethyl sulfate are added dropwise to a suspension of 6.22 g (13.96 mmol) of 4,4″-bis(4-methyl-piperazin-1-yl)-1′H-[2,2′;6′,2″]terpyridin-4′-one (L34 in Example 43) in 250 ml of acetone. After 20 hours, twofold-quaternised whitish 4,4″-bis(4-methyl-piperazin-1-yl)-1′H-[2,2′;6′,2″]terpyridin-4′-one is filtered off and washed (acetone). C₂₉H₄₃N₇O₉S₂*0.39H₂O, 704.86; calculated C, 49.42; H, 6.26; N, 13.91; S, 9.10; H₂O, 1.00. found C, 49.30; H, 6.19; N, 13.85; S, 8.99; H₂O, 1.00.

¹H-NMR (360 MHz, D₂O): 8.08 (d, J=5.9 Hz, 2H); 7.18 (dm, 2H); 6.79 (dd, J=5.9, 2.3 Hz); 6.74 (s, 2H); 3.77-3.68 (m, 8H); 3.65 (s, 6H); 3.59-3.50 (m, 8H).

### Example 46a

### 4,4″-Bis-[(2-dimethylamino-ethyl)-methyl-amino]-1′H-[2,2′;6′,2″]terpyridin-4′-one (Hereinafter Called L38)

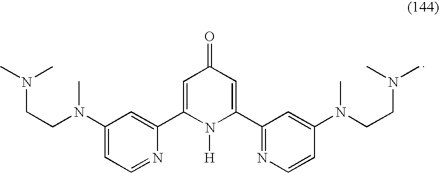

A mixture of 1.70 g (5.34 mmol) of 4,4″-dichloro-1′H-[2,2′;6′,2″]terpyridin-4′-one (L16 in Example 25), 13.8 ml (107 mmol) of N,N,N′-trimethyl-ethane-1,2-diamine and 36 mg (0.27 mmol, 0.05 equivalent) of zinc(II) chloride in 30 ml of chlorobenzene is refluxed for 2.5 days and concentrated to dryness using a rotary evaporator. The crude product is taken up in 30 ml of water and adjusted to pH 6-7, and after filtration, 4,4″-Bis-[(2-dimethylamino-ethyl)methyl-amino]-1′H-[2,2′;6′,2″]terpyridin-4′-one, containing 1.95 equiv. HCl and 1.20 equiv. H₂O (elemental analysis) is obtained as an off-white solid.

¹H-NMR (360 MHz, D₂O): 7.99 (d, 2H, J=6.8 Hz); 6.98 (d, 2H, J=1.8 Hz); 6.90 (s, 2H); 6.71 (m, 2H); 3.72 (tm, 4H); 3.10 (tm, 4H); 3.06 (s, 6H); 2.70 (s, 12H).

### Example 46b

### Twofold Quaternisation of 4,4″-Bis-[(2-dimethylamino-ethyl)-methyl-amino]-1′H-[2,2′;6′,2″]terpyridin-4′-one with Methyl Iodide (Hereinafter Called L39)

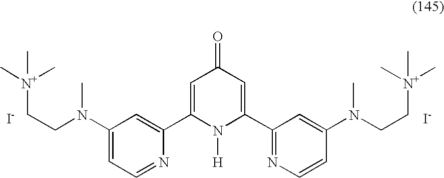

A suspension of 162.7 mg (0.3 mmol) 4,4″-is-[(2-dimethyamino-ethyl)-methyl-amino]-1′H-[2,2′;6′,2″]terpyridin-4′-one (L38 in Example 46a) is neutralized with 5.6 ml 0.1 M HCl solution in 5 ml of water. After evaporation, the material is suspended in 4 ml of acetonitrile and treated with a freshly prepared stock solution of methyl iodide (0.6 mmol in 2.1 ml of acetonitrile). Stirring for 16 hours at room temperature and filtration are carried out, and the resulting twofold-quaternised ligand (C₂₇H₄₁I₂N₇O) is washed (acetonitrile).

¹H-NMR (360 MHz, D₂O): 8.13 (d, 2H, J=6.3 Hz); 7.09 (d, 2H, J=3.3 Hz); 6.97 (s, 2H); 6.74 (m, 2H); 3.96 (tm, 4H); 3.54 (tm, 4H); 3.20 (s, 18H); 3.06 (s, 6H).

### Examples 46c-46z

In analogy to the above described Examples the following compounds were synthesized:

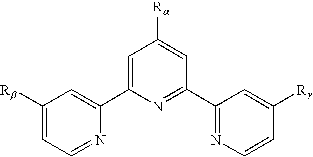

| | R_{α} | R_{β} | R_{γ} |
|---|---|---|---|
| 46c | —NH₂ | H | H |
| 46d | —OCH₃ | H | H |
| 46e | —N(CH₃)₂ | H | H |
| 46f | —OH | —OH | —OH |
| 46g | —OH | 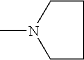 | H |
| 46h | —OH | —N(CH₃)₂ | —N(CH₃)₂ |
| 46i | 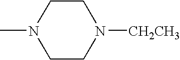 | H | H |
| 46j | —OH | 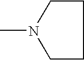 | 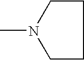 |
| 46k | —OCH₃ | —N(CH₃)(CH₂CH₂OH) | —N(CH₃)(CH₂CH₂OH) |
| 46l | —OH | 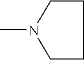 | 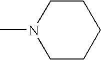 |
| 46m | —OH | 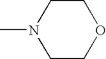 | 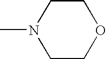 |
| 46n | —OH | —N(CH₂CH₃)(CH₂CH₂OH) | —N(CH₂CH₃)(CH₂CH₂OH) |
| 46o | 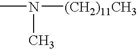 | H | H |
| 46p | —OH | 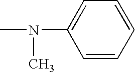 | 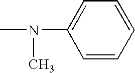 |
| 46p′ | —OH | 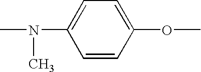 | 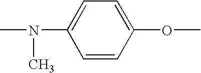 |
| 46p″ | —OH | 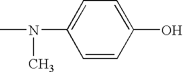 | 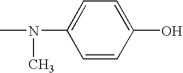 |
| 46q | —OH | 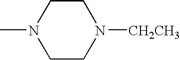 | 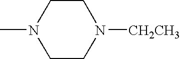 |
| 46r | —OH | 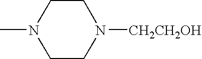 | 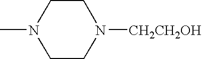 |
| 46s | —OH | 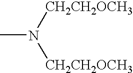 | 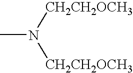 |
| 46t | —OH | 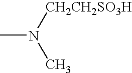 | 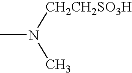 |
| 46u | 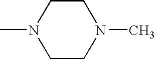 | 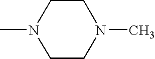 | 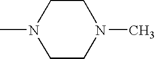 |
| 46v | —OH | 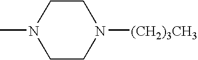 | 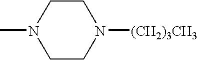 |
| 46w | —OH | 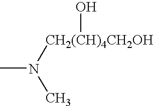 | 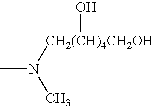 |
| 46x | —OH | 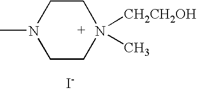 | 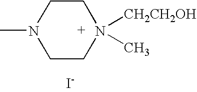 |
| 46y | —OH | 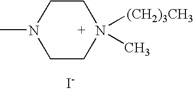 | 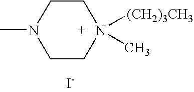 |
| 46z | 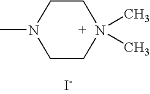 | 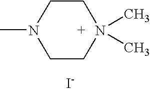 | 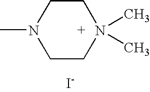 |

### Synthesis of Compounds of the Pyrimidine Type

### Example 47

### 6-(4-Chloropyrid-2-yl)-2-pyrid-2-yl-pyrimidin-4-ol (Ligand PM1)

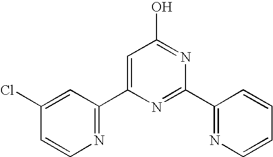

13.15 g (58 mmol) of 3-(4-chloropyrid-2-yl)-3-oxopropionic acid ethyl ester (example 18) are dissolved in 400 ml of ethanol, and 9.10 g (58 mmol) of 2-amidinopyridine hydrochloride are added. After the addition of 14.44 ml of 4N sodium hydroxide solution, refluxing is carried out for 7 hours. The mixture is cooled and concentrated to a fifth of its original volume. The crude product is filtered off and recrystallised from methanol, yielding 6-(4-chloropyrid-2-yl)-2-pyrid-2-yl-pyrimidin-4-ol in the form of beige needles.

¹H-NMR (360 MHz, CDCl₃): 12.33 (br s, 1H); 8.76 (d, J=4.5 Hz, 1H); 8.69 (d, J=5.4 Hz, 1H); 8.62 (d, J=7.7 Hz, 1H); 8.50 (d, J=1.8 Hz, 1H); 8.15-8.03 (tm, 1H); 7.75-7.63 (m, 2H); 7.25 (s, 1H).

### Example 48

### 6-[4-(4-methyl-piperazin-1-yl)-pyrid-2-yl]-2-pyrid-2-yl-pyrimidin-4-ol (Ligand PM1PM2)

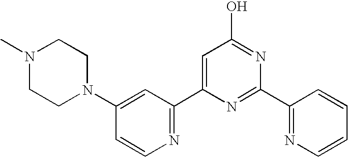

A mixture of 3.51 g (12.3 mmol) of 6-(4-chloropyrid-2-yl)-2-pyrid-2-yl-pyrimidin-4-ol, 27.4 ml (303 mmol, 20 equivalents, 30.38 g) of 1-methyl-piperazine and 84 mg (0.05 mmol, 0.05 equivalent) of zinc(II) chloride in 50 ml of 2-methyl-2-butanol is refluxed for 22 hours and concentrated to dryness using a rotary evaporator. 50 ml of water are added, 3.6 g of EDTA are added, and the pH is adjusted to 9 using dilute sodium hydroxide solution. Extraction is carried out three times using 150 ml of chloroform each time, and the organic extracts are combined and dried (sodium sulfate). Concentration is carried out using a rotary evaporator and the crude product is recrystallised from toluene. 6-[4-(4-Methyl-piperazin-1-yl)-pyrid-2-yl]-2-pyrid-2-yl-pyrimidin-4-ol is obtained in the form of a whitish solid.

¹H-NMR (360 MHz, CDCl₃): 10.99 (br s, 1H); 8.56 (d, J=4.1 Hz, 1H); 8.44 (d, J=7.7 Hz, 1H); 8.25 (d, J=5.9 Hz, 1H); 7.91-7.81 (tm, 1H); 7.78 (s, 1H); 7.48-7.33 (tm, 1H); 6.66-6.56 (m, 1H); 3.39 (t, J=5.0 Hz, 4H); 2.53 (t, J=5.0 Hz, 4H); 2.30 (s, 3H).

### Example 49

### Quatemisation of 6-[4-(4-methyl-piperazin-1-yl)-pyrid-2-yl]-2-pyrid-2-yl-pyrimidin-4-ol with Methyl Iodide to Form Ligand PM3

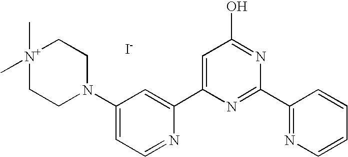

417 mg (2.94 mmol, 0.98 equivalent) of methyl iodide are added dropwise to a suspension of 1.045 g (3 mmol) of 6-[4-(4-methyl-piperazin-1-yl)-pyrid-2-yl]-2-pyrid-2-yl-pyrimidin-4-ol in 20 ml of acetonitnle. The mixture is stirred for 14 hours at room temperature, then heated to 60° C. for 10 minutes and cooled, and the resulting quaternised 6-[4-(4-methyl-piperazin-1-yl)-pyrid-2-yl]-2-pyrid-2-yl-pyrimidinol is filtered off in the form of a white powder.

¹H-NMR (360 MHz, D₂O): 8.33 (d, J=4.5 Hz, 1H); 7.73-7.64 (m, 1H); 7.64-7.56 (m, 1H); 7.42-7.31 (m, 2H); 6.78 (d, 2.3 Hz, 1H); 6.33 (s, 1H); 6.31-6.26 (m, 1H).

### Example 50

### 2,6-Di(2-pyridyl)-4-pyrimidinol (Ligand PM4)

(Obtainable from Bionet, Order No. 11G-917)

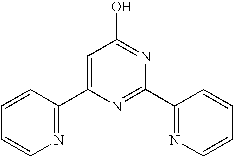

ESI-MS: m/z=251 [M+H]⁺.

### Example 51

### 4-Chloro-2-cyanopyridine

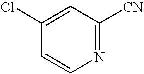

5.0 ml (0.16 equivalent) of N,N-dimethylformamide are added dropwise at 40° C., with stirring, to 150 ml (2.06 mol) of thionyl chloride. Then, in the course of half an hour, 50 g (0.406 mol) of picolinic acid are added. The mixture is cautiously heated to 70° C. and stirred at that temperature for 24 hours, the gases formed being conveyed away through a wash bottle charged with sodium hydroxide solution. Concentration, and coevaporation a further three times with 50 ml of toluene each time, are carried out. 300 ml of diethyl ether are added to the acid chloride-hydrochloride so obtained. The mixture is cooled to 0° C. using an ice/water bath, and 250 ml of 25% ammonium hydroxide solution are cautiously added. The mixture is warmed to room temperature and stirred for 16 hours to complete the reaction. Filtration is carried out, and the filter residue is boiled in 400 ml of chloroform to remove secondary products and recrystallised from 350 ml of methanol. 4-Chloro-2-picolinic acid amide is obtained in the form of a yellowish solid, which is reacted without further purification. 31.3 g (0.2 mol) of the amide obtained in that manner are suspended in 490 ml of dichloromethane and cooled to 0° C. using an ice/water bath. After the addition of 46.5 ml of N,N-dimethylformamide, 36.7 ml of phosphorus oxychloride are added dropwise in the course of 20 minutes while maintaining the temperature, and stirring is carried out for a further 6 hours with cooling. 100 ml of water are then added and the mixture is rendered neutral with 4N sodium hydroxide solution and stirred overnight at room temperature. The organic solvent is removed using a rotary evaporator, and the aqueous phase is extracted three times using 250 ml of chloroform each time. After concentrating and drying the crude product under a high vacuum, sublimation is carried out at from 70 to 90° C. and 0.2 mbar, yielding 4-chloro-2-cyanopyridine in the form of a yellowish solid.

¹H-NMR (360 MHz, CDCl₃): 8.64 (d, 5.0 Hz, 1H); 7.72 (d, J=1.8 Hz, 1H); 7.56 (dd, J=5.0.

1.8 Hz, 1H).

### Example 52

### 2-Amidino-4-chloropyridine Hydrochloride

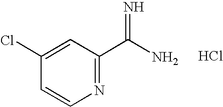

6.93 g (50 mmol) of 4-chloro-2-cyanopyridine in 40 ml of methanol are treated for one hour with 0.27 g (5 mmol) sodium methoxide. After the addition of 3.00 g (56 mmol) of ammonium chloride, refluxing is carried out for two hours. The volatile components are then removed in vacuo. The 2-amidino-4-chloropyridine hydrochloride so obtained is reacted without further purification.

¹H-NMR (360 MHz, D₂O): 8.61-8.57 (dm, 1H); 8.05 (s, 1H); 7.77-7.80 (m, 2H).

### Example 53

### 2,6-Bis(4-chloropyrid-2-yl)-pyrimidin-4-ol (Ligand PM5)

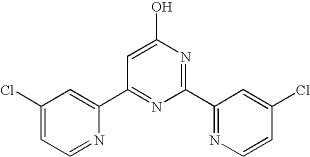

The procedure is as described in the case of 6-(4-chloropyrid-2-yl)-2-pyrid-2-yl-pyrimidin-4-ol (ligand PM1) in Example 47 except that, instead of 2-amidinopyridine hydrochloride, the 2-amidino-4-chloropyridine hydrochloride from Example 52 is used. After recrystallisation from DMSO, 2,6-bis(4-chloropyrid-2-yl)pyrimidin-4-ol (ligand PM5) is obtained in the form of a colourless solid. ¹H-NMR (360 MHz, DMSO-d₆): 12.53 (br s, 1H); 8.74 (d, J=5.0 Hz, 1H); 8.74 (s, 1H); 8.71 (d, J=5.0 Hz, 1H); 8.64 (d, J=2.3 Hz, 1H); 7.83 (dd, J=5.0, 2.3 Hz, 1H); 7.71 (dd, J=5.0, 2.3 Hz, 1H); 7.30 (s, 1H).

### Example 54

### 2,6-Bis[4-(4-methyl-piperazin-1-yl)-pyrid-2-yl]-pyrimidin-4-ol (Ligand PM6)

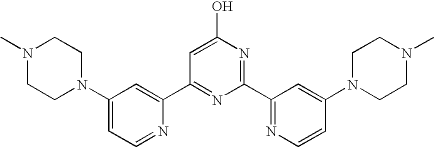

A mixture of 1.16 g (3.62 mmol), 8.04 ml (72 mmol) of N-methyl piperazine, 25 mg of zinc(II) chloride and 36 ml of 2-methyl-2-butanol is refluxed for 16 hours, cooled and filtered, and recrystallisation from 2-propanol is carried out 2,6-Bis[4-(4-methyl-piperazin-1-yl)-pyrid-2-yl]-pyrimidin-4-ol (ligand PM6) is obtained in the form of a yellowish solid.

¹H-NMR (360 MHz, DMSO-d₆): 11.92 (br s, 1H); 8.31 (d, J=5.9 Hz, 1H); 8.30 (d, J=−5.9 Hz, 1H); 7.94 (br s, 2H); 7.16 (s, 1H); 7.08 (dd, J=6.3, 2.7 Hz, 1H); 6.958 (dd, J=6.3, 2.7 Hz, 1H); 3.52-3A41 (m, 8H); 2.54-2.49 (m, 4H); 2.48-2.43 (m, 4H); 2.24 (s, 6H).

### Example 55

### Quatemisation of 2,6-bis[4-(4-methyl-piperazin-1-yl)-pyrid-2-yl]-pyrimidinol (Ligand PM6) with Methyl Iodide to Form Ligand PM7

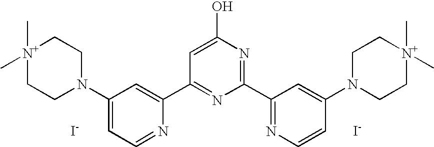

0.12 ml (1.84 mmol) of methyl iodide is added to 411 mg (0.92 mmol) of 2,6-bis[4-(4-methyl-piperazin-1-yl)-pyrid-2-yl]-pyrimidin-4a1 (ligand PM6) from Example 54 in 18 ml of acetonitrile. The mixture is stirred for 16 hours at room temperature and filtered, and the residue is washed with chloroform. The quaternised ligand PM7 is obtained in the form of a colourless solid.

¹H-NMR (360 MHz, D₂O): 8.25 (d, J=6.3 Hz, 1H); 8.19 (d, J=5.9 Hz, 1H); 7.78 (d, J=−2.7 Hz, 1H); 7.50 (d, J=2.3 Hz, J=1H); 7.05 (dd, J=6.3 Hz, 2.7 Hz, 1H); 6.92 (dd, J=5.9 Hz, 2.3 Hz, 1H); 6.89 (s, 1H); 3.88-3.83 (tm, 4H); 3.81-3.76 (tm, 4H); 3.66-3.61 (m, 8H); 2.30 (s, 3H); 2.28 (s, 3H).

### Example 55a

In analogy to the above described Examples the ligand of the following formula can be synthesized:

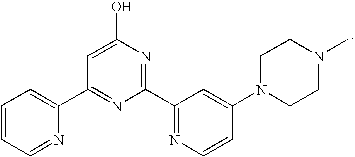

### Example 55b

In analogy to the above described Examples the ligand of the following formula can be synthesized:

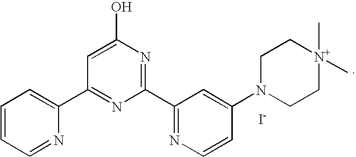

### Synthesis of Compounds of the Triazine Type

### Example 56

### 4,6-Di-pyrid-2-yl-[1,3,5]triazin-2-ol (Ligand TZ1)

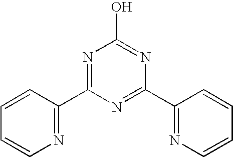

1.0 g (approximately 60% dispersion in paraffin oil, about 25 mmol) of sodium hydride is added in portions to a solution of 5.21 g (50 mmol) of 2-cyanopyridine and 1.50 g (25 mmol) of urea in 100 ml of dimethyl sulfoxide. The resulting suspension is maintained at room temperature for 3 hours and then heated at 75° C. for 23 hours, cooled and poured into 100 ml of ice-water. The mixture is rendered neutral with 2N sulfuric acid, and the crude product is filtered off and recrystallised from 55 ml of methanol, yielding 4,6-di-pyrid-2-yl-[1,3,5]triazin-2-ol in the form of a white solid.

¹H-NMR (360 MHz, CD₃OD): 8.68-8.6 (m, 4H); 7.95 (ddd, J=7.7, 7.7, 1.8 Hz, 2H); 7.50 (ddd, J=7.7, 4.5, 1.4 Hz, 2H).

### Example 57

### 4,6-Di-pyrid-2-yl-[1,3,5]triazin-2-ylamine (Ligand TZ2)

Synthesis according to F. H. Case et al., J. Am. Chem. Soc. 1959, 81, 905-906.

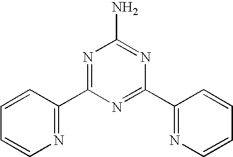

1.0 g (approximately 60% dispersion in paraffin oil, about 25 mmol) of sodium hydride is added in portions to a mixture of 5.21 g (50 mmol) of 2-cyanopyridine and 2.39 g (25 mmol) of guanidine hydrochloride in 100 ml of dimethyl sulfoxide. Stirring is carried out for 2 hours at room temperature, and then for 23 hours at 75° C. The mixture is cooled and poured into 100 ml of ice-water and filtered, yielding 4,6-di-pyrid-2-yl-[1,3,5]triazin-2-ylamine in the form of a white solid after drying in vacuo.

¹H-NMR (360 MHz, DMSO-d₆): 8.82-8.73 (md, 2H); 8.44 (d, J=8.1 Hz, 2H); 8.10-7.95 (tm, 2H); 7.90 (br s, 2H); 7.64-7.55 (m, 2H).

### Synthesis of Metal Complexes

### Example 58

### Manganese(II) Complex with a Pyridone Ligand: {[2,2′;6′,2″]terpyridin-4′-ol}manganese(II)Chloride

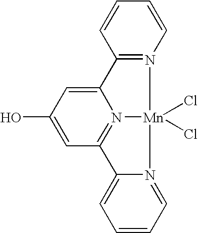

The synthesis of this compound is done in analogy of Example 37 (page 37) of WO 02/088289.

### Example 59

### Manganese(II) Complex with a Substituted Terpyridine Ligand: {2-[(2-hydroxy-ethyl)-[2,2′;6′,2″]terpyrid-4′-yl-amino]-ethanol}manganese(II) Chloride

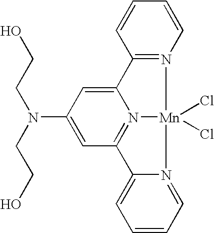

The synthesis of this compound is done in analogy of Example 38 (page 46) of WO 02/088289.

### Example 59a

### {2-(Methyl-[2,2′;6′,2″]terpyridin-4′-yl-amino)-ethanol}manganese(II) Chloride

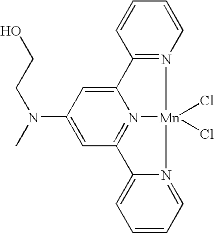

The synthesis of this compound is done in analogy of Example 38a (page 47) of WO 02/088289.

### Example 60

### Manganese(II) Complex with Two Substituted Terpyridine Ligands: bis{2-[(2-hydroxy-ethyl)-[2,2′;6′,2″]terpyrid-4′-yl-amino]-ethanol}manganese(II) Chloride

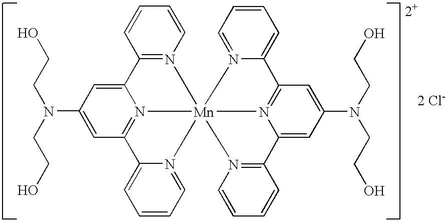

The synthesis of this compound is done in analogy of Example 39 (page 47) of WO 02/088289.

### Example 61

### Bis{4,4″-bis[(2-hydroxy-ethyl)-methyl-amino]-[2,2′;6′,2″]terpyridin-4′-ol}manganese(II) Chloride

The synthesis of this compound is done in analogy of Example 40 (page 48) of WO 02/088289.

### Example 62

### Manganese(II) Complex with 1,1-dimethyl-4-(4′-oxo-1′,4′-dihydro-[2,2′;6′,2″]terpyrid-4-yl)-piperazin-1-ium Methosulfate

A solution of 37.6 mg (0.19 mmol) of manganese(II) chloride tetrahydrate in 4 ml of methanol is added to a suspension of 1,1-dimethyl-4-(4′-oxo-1′,4′-dihydro-[2,2′;6′,2″]terpyrid-4-yl)-piperazin-1-ium methosulfate (L33 in Example 42) in 4 ml of methanol. Concentration using a rotary evaporator (30° C., 20 mbar final pressure) is then carried out. The manganese complex of formula C₂₂H₂₇Cl₂MnN₅O₅S*0.38H₂O (Fw=606.24) is obtained in the form of a yellow powder; calculated C, 43.59; H, 4.62; N, 11.55; S, 5.29; Cl, 11.70; Mn, 9.06; H₂O, 1.13.

found C, 43.54; H, 4.50; N, 11.73; S, 5.07; Cl, 11.69; Mn, 9.06; H₂O, 1.14.

### Example 63

### Manganese complex with 4,4″-bis(4-methyl-piperazin-1-yl)-1′H-[2,2′;6′,2″]terpyridin-4′-one

One equivalent of ligand L34 (Example 43) hydrochloride is added to a solution of 2.33 g (11.8 mmol) of manganese(II) chloride tetrahydrate in 100 ml of water. The solution is then freeze-dried. The manganese complex of formula C₂₅H₃₁Cl₂MnN₇O*3.73H₂O*2.31HCl is obtained in the form of a yellow solid.

Calculated C 46.06; H 6.30; N 15.04 Cl 12.56 Mn 8.43H₂O 10.31.

found C, 46.02; H, 5.84; N 14.99; Cl, 12.54; Mn, 8.17; H₂O, 10.52.

### Example 64

### Manganese Complex with Twofold-Quaternised 4,4″-bis(4-methyl-piperazin-1-yl)-1′H-[2,2′;6′,2″]terpyridin-4′-one

One equivalent of ligand L37 (Example 46) is added to a solution of 2.64 g (13.33 mmol) of manganese(II) chloride tetrahydrate in 350 ml of water. The solution is then freeze-dried. The manganese complex of formula C₂₉H₄₃Cl₂MnN₇O₉S₂*3.62H₂O is obtained in the form of a yellow solid.

Calculated C 39.19; H 5.70; N 11.03 Cl 7.98 Mn 6.18H₂O 7.34,

found C, 38.68; H 5.65; N 10.73; Cl, 7.77; Mn, 5.97; H₂O, 7.33.

### Example 64a

### Manganese(II) complex with twofold-quaternised 4,4″-bis(4-methyl-piperazin-1-yl)-1′H-[2,2;6′,2″]terpyridin-4′-one

A solution of 119 mg (0.6 mmol) of manganese(II) chloride tetrahydrate in 11 ml of methanol is added to a suspension of 419 mg (0.6 mmol) of ligand C₂₉H₄₃N₇O₉S₂ (L37 in Example 46). Concentration is then carried out using a rotary evaporator (30° C., 20 mbar final pressure). The manganese complex of formula C₂₉H₄₃Cl₂MnN₇O₉S₂*2.22H₂O (Fw 863.67) is obtained in the form of a yellow powder;

calculated C, 40.33; H, 5.54; N, 11.35 S, 7.43; C, 18.21; Mn, 6.36; H₂O, 4.63.

found C, 41.10; H, 5.35; N, 11.77; S, 7.18; Cl, 8.36; Mn, 5.91; H₂O, 4.64.

Synthesis of higher-valent manganese complexes with substituted ligands of the terpyridine type (Examples 65 to 67) [compare method by J. Limburg et al., Science 1999, 283, 1524-1527 for terpyridine]:

### Example 65

1.78 g (7.14 mmol) of 1′H-[2,2′;6′,2″]terpyridin-4′-one L1 are added to a solution of 1.75 g (7.14 mmol) of manganese(II) acetate tetrahydrate in 35 ml of water. A solution of 3.28 g (9.93 mmol of active oxygen in the form of KHSO₅) of potassium peroxomonosulfate in 20 ml of water Is then added dropwise. The mixture is subsequently stirred for 2 hours at mom temperature, then filtered off with suction and washed with 25 ml of water. Drying, is carried out for 12 hours at 50° C. in vacuo to yield 2.05 g of olive-green powder.

IR (cm⁻¹): 3068 (m), 1613 (m), 1602 (m), 1587 (s), 1480 (m), 1099 (vs), 1053 (w), 1028 (s), 1011 (s), 788 (m).

### Example 66

1.23 g (5 mmol) of manganese(II) acetate tetrahydrate are added to a suspension of 1.68 g (5 mmol) of 2-[(2-hydroxy-ethyl)-[2,2′;6′,2′]terpyridin-4′-yl-amino]-ethanol L7. A solution of 1.44 g (4.37 mmol of active oxygen in the form of KHSO₅) of potassium peroxomonosulfate in 30 ml of water is then added dropwise. A total of 25 ml of 1 M ammonium hexafluorophosphate solution are added dropwise to the now red solution. The precipitate is filtered off and washed twice with 10 ml of water each time. The red solid is then taken up in 30 ml of acetonitrile, filtered through a paper filter and concentrated. The residue remaining is extracted with dichloromethane for 16 hours in a Soxhlet apparatus and then dried in vacuo at 50° C. 2.15 g of wine-red powder are obtained.

IR (cm⁻¹): 2981 (s), 2923 (s), 2866 (m), 2844 (m), 1621 (s), 1571 (w), 1537 (w), 1475 (s), 1356 (m), 1055 (s), 1032 (vs), 1011 (s), 829 (vs), 784 (s), 740 (w).

### Example 67

99 mg (0.5 mmol) of manganese(II) chloride tetrahydrate are added to a suspension of 168 mg (0.5 mmol) of 2-[(2-hydroxy-ethyl)-[2,2′;6′,2″]terpyrid-4′-yl-amino]-ethanol L7. A solution of 144 mg (0.44 mmol of active oxygen in the form of KHSO₅) of potassium peroxomonosulfate in 3 ml of water is then added dropwise. The almost black solid is filtered off and dried in vacuo at 50° C.

IR (cm⁻¹): 3324 (br, m), 3076 (br), 1614 (s), 1523 (w), 1476 (m), 1154 (w), 1055 (w), 1025 (vs), 925 (w), 647 (s).

### Example 67a

### Manganese Complex with Twofold-Quaternised 4,4′-Bis-[(2-dimethylamino-ethyl)-methyl-amino]-1′H-[2,2′;6′,2″]terpyridin-4′-one

One equivalent of ligand L39 (Example 46b) is added to a solution of one equivalent of manganese(II) chloride tetrahydrate in water. Spontaneous complex formation is observed.

### Example 68

### Manganese Complex with 6-[4-(4-methyl-piperazin-1-yl)-pyrid-2-yl]-2-pyrid-2-yl-pyrimidin-4-ol (Ligand PM2)

503 mg (2.5 mmol) of manganese chloride tetrahydrate are added to a solution of 886 mg (2.5 mmol) of 6-[4-(4-methyl-piperazin-1-yl)pyrid-2-yl]-2-pyrid-2-yl-pyrimidin-4-ol in 200 ml of water. The solution is then freeze-dried. C₁₉H₂₀Cl₂MnN₈O×2.92H₂O, yellow solid.

Calculated C, 43.32; H, 4.94; N, 15.95; Cl, 13.46; Mn, 10.43; H₂O, 9.98.

found C, 43.10; H, 4.95; N, 16.03; Cl, 13.29; Mn, 10.4; H₂O, 9.99.

### Example 69

### Manganese Complex with Quaternised 6-[4-(4-methyl-piperazin-1-yl)-pyrid-2-yl]-2-pyrid-2-yl-pyrimidin-4-ol (Ligand PM3)

119 mg (0.6 mmol) of manganese chloride tetrahydrate are added to a solution of 294 mg (0.6 mmol) of quaternised 6-[4-(4-methyl-piperazin-1-yl)-pyrid-2-yl]-2-pyrid-2-yl-pyrimidinol in 200 ml of water. The solution is then freeze-dried. C₂₀H₂₃Cl₂MnN₈O×3.75H₂O, yellowish orange solid.

Calculated C, 35.13; H, 4.50; N, 12.29; Cl, 10.37; Mn, 8.03; H₂O, 9.88.

found C, 35.38; H, 5.00; N, 12.39; Cl, 10.70; Mn, 7.99; H₂O, 9.87.

### Application Examples

### Application Example 1

### Stain Bleaching with Peracetic Acid at Model Stains

1 g of a circular stain (BC1 (CFT); WFK10.T (WFK); BC04 (CFT), or CS8/2 (CFT)) is added into a vial with 3 mL washing liquor. The liquor contains a standard washing agent (IEC 60456*, WFK) in a concentration of 7.5 g/l. The peracetic acid concentration is 3 mmol/l. The catalyst concentration (either a 1:1 in-situ complex of the ligand with manganese(II) chloride tetrahydrate in methanolic or aqueous solution or an isolated 1:1 complex) is 10 μmol/l. The vial is shaken with a shaker for 50 minutes at ambient temperature. After the treatment the fabric is carefully rinsed and ironed. The brightness values Y according to the CIE standard procedure of the stained test fabrics is measured with a Gretag SPM 100 instrument prior to and after the treatment. The bleaching effect is given as ΔΔY, i.e. the difference between the brightness in the presence and in the absence of a catalyst.

| | | Ketchup | Tomato | Curry | Grass CS |
|---|---|---|---|---|---|
| | BC1 tea | WFK10.T | CS20/2 | BC04 | 8/2 |
| Compound | ΔΔY (10 μM) | ΔΔY(10 μM) | ΔΔY(10 μM) | ΔΔY(10 μM) | ΔΔY(10 μM) |
| Mn complex | 9.2 | 1.7 | 0.2 | 5.1 | 0.9 |
| with L32 | | | | | |
| complex of | 10.5 | 0.5 | 0.4 | 6.3 | 1.5 |
| example 63 | | | | | |
| complex of | 11.1 | 0 | 5.4 | 7.3 | 3.2 |
| example 61 | | | | | |

As can be seen from the table above, the presence of manganese complexes of the present invention considerably improves the bleach performance obtained with peracetic acid only at different bleachable stains.

### Application Example 2

### Bleaching of Tea Stains with Peracetic Acid in a Washing Experiment

30 g of white cotton fabric and 2.0 g of tea-stained cotton fabric (BC-01; CFT) ae treated in 160 ml of washing liquor. The liquor contains a standard washing agent (IEC 60456*, WFK) in a concentration of 7.5 g/l. The peracetic acid (PA) concentration is 3 mmol/l. The catalyst concentration is varied between 5 and 15 μmol/l. The washing process is carried out in a steel beaker in a LINITEST apparatus for 50 minutes at 30° C. After the wash the fabric was carefully rinsed, spin-dried and ironed. For evaluating the bleaching results, the increase in the brightness ΔY (difference in brightness according to CIE) of the stains brought about by the treatment is determined spectrophotometrically in comparison with values obtained without the addition of catalyst.

| | ΔY at 5 μM | ΔY at 10 μM | ΔY at 15 μM |
|---|---|---|---|
| Compound | catalyst | catalyst | catalyst |
| PA (no catalyst) | 10.7 | 10.7 | 10.7 |
| PA + complex of | 22.0 | 24.5 | 24.6 |
| example 63 | | | |
| PA + complex of | 23.1 | 24.8 | 24.7 |
| example 61 | | | |
| PA + complex of | 13.1 | 14.2 | 15.4 |
| example 58 | | | |
| PA + complex of | 14.6 | 16.2 | 18.6 |
| example 64 | | | |
| PA + complex of | 12.4 | 13.3 | 13.4 |
| example 59a | | | |

As can be seen from the table above, the presence of manganese complexes of the present invention considerably improves the bleach performance obtained with peracetic acid only.

### Application Example 3

### Bleaching of Tea Stains with (ε-Phthalimido Peroxy Hexanoic Acid in a Washing Experiment)

30 g of white cotton fabric and 2.0 g of tea-stained cotton fabric (BC-01; CFT) are treated in 160 ml of washing liquor. The liquor contains a standard washing agent (IEC 60456*) in a concentration of 7.5 g91. The PAP (ε-phthalimido peroxy hexanoic acid) concentration is 4 mmol/l. The catalyst concentration is varied between 5 and 15 μmol/l. The washing process is carried out in a steel beaker in a LINITEST apparatus for 50 minutes at 30° C. After the wash the fabric was carefully rinsed, spin-dried and ironed. For evaluating the bleaching results, the increase in the brightness ΔY (difference in brightness according to CIE) of the stains brought about by the treatment is determined spectrophotometrically in comparison with values obtained without the addition of catalyst

| | ΔY at 5 μM | ΔY at 10 μM | ΔY at 15 μM |
|---|---|---|---|
| Compound | catalyst | catalyst | catalyst |
| PAP (no catalyst) | 16.3 | 16.3 | 16.3 |
| PAP + complex of | 26.2 | 27.2 | 28.1 |
| example 63 | | | |
| PAP + complex of | 24.6 | 26.1 | 26.6 |
| example 61 | | | |
| PAP + complex of | 22.7 | 24.7 | 25.9 |
| example 58 | | | |
| PAP + complex of | 20.2 | 23.6 | 24.3 |
| example 64 | | | |
| PAP + complex of | 18.6 | 19.8 | 20.7 |
| example 59a | | | |

As can be seen from the table above, the presence of manganese complexes of the present invention considerably improves the bleach performance obtained with PAP only.

### Application Example 4

### Bleaching of Tea Stains with Peracetic Acid Formed from Hydrogen Peroxide and TAED in a Washing Experiment

In this example peracetic acid is formed in situ by perhydrolysis of TAED with hydrogen peroxide. 30 g of white cotton fabric and 2.0 g of teastained cotton fabric (BC-01; CFT) are treated in 160 ml of washing liquor. The liquor contains a standard washing agent (IEC 60456*) in a concentration of 7.5 g/l. The hydrogen peroxide concentration is 3 mM and the TAED concentration is 1.5 mM. The maximum theoretical concentration of peracetic acid formed is hence 3 mM. The catalyst concentration is varied between 5 and 15 μmol/l. The washing process is carried out in a steel beaker in a LINITEST apparatus for 50 minutes at 30° C. After the wash the fabric was carefully rinsed, spin-dried and ironed. For evaluating the bleaching results, the increase in the brightness ΔY (difference in brightness according to CIE) of the stains brought about by the treatment is determined spectrophotometrically in comparison with values obtained without the addition of catalyst

| | ΔY at 5 μM | ΔY at 10 μM | ΔY at 15 μM |
|---|---|---|---|
| Compound | catalyst | catalyst | catalyst |
| H2O2 + TAED (no catalyst) | 8.1 | 8.1 | 8.1 |
| H2O2 + TAED + complex of | 15.6 | 17.6 | 18.0 |
| example 63 | | | |
| H2O2 + TAED + complex of | 16.9 | 18.8 | 18.6 |
| example 61 | | | |
| H2O2 + TAED + complex of | 8.6 | 9.8 | 10.4 |
| example 58 | | | |
| H2O2 + TAED + complex of | 10.8 | 14.0 | 14.5 |
| example 64 | | | |

As can be seen from the table above, the addition of manganese complexes of the present invention considerably improves the bleach performance obtained with H₂O₂+TAED.

1. A method of oxidizing an oxidizable substrate which comprises bringing an oxidizable substrate into contact with at least one metal complex of formula (1)
[LₙMeₘXₚ]^{z}Y_{q} (1),
wHerein
Me is manganese; titanium; iron; cobalt; nickel or copper,
X is a coordinating or bridging radical,
n and m are each independently of the other an integer having a value of from 1 to 8,
p is an integer having a value of from 0 to 32,
z is the charge of the metal complex,
Y is a counter-ion,
q=z/(charge of Y), and
L is a ligand of formula (2) 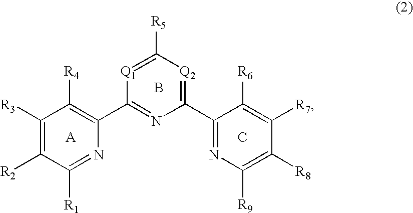
wherein
Q₁ is N or CR₁₀,
Q₂ is N or CR₁₁,
R₁, R₂, R₃, R₄, R₅, R₇, R₈, R₉, R₁₀ and R₁₁ are each independently of the others hydrogen;
unsubstituted or substituted C₁-C₁₈alkyl or unsubstituted or substituted aryl; cyano; halogen; nitro; —COOR₁₂ or —SO₃R₁₂ wherein
R₁₂ is in each case hydrogen, a cation or unsubstituted or substituted C₁-C₁₈alkyl or unsubstituted or substituted aryl;
—SR₁₃; —SO₂R₁₃ or —OR₁₃ wherein
R₁₃ is in each case hydrogen or unsubstituted or substituted C₁-C₁₈alkyl or unsubstituted or substituted aryl;
—NR₁₄R₁₅; —(C₁-C₆alkylene)-NR₁₄R₁₅; —N^{⊕}R₁₄R₁₅R₁₆; —(C₁-C₆alkylene)-N^{⊕}R₁₄R₁₅R₁₆; —N(R₁₃)—(C₁-C₆alkylene)-NR₁₄R₁₅; —N[(C₁-C₆alkylene)-NR₁₄R₁₅]₂;
—N(R¹³)—(C₁-C₆alkylene)-N^{⊕}R₁₄R₁₅R₁₆; —N[(C₁-C₆alkylene)-N^{⊕}R₁₄R₁₅R₁₆]₂; —N(R₁₃)—N—R₁₄R₁₅ or —N(R₁₃)—N^{⊕}R₁₄R₁₅R₁₆, wherein
R₁₃ is as defined above and
R₁₄, R₁₅ and R₁₆ are each independently of the other(s) hydrogen or unsubstituted or substituted C₁-C₁₈alkyl or unsubstituted or substituted aryl, or
R₁₄ and R₁₅, together with the nitrogen atom linking them, form an unsubstituted or substituted 5-, 6- or 7-membered ring which may contain further hetero atoms,
as catalysts for oxidation reactions with organic peroxy acids and/or precursors of organic peroxy acids and H₂O₂ and or a precursor of H₂O₂.

2. A methods according to claim 1, wherein Me is manganese, which is in oxidation state II, III, IV or V.

3. A method according to claim 1, wherein
X is CH₃CN, H₂O, F⁻, Cl⁻, Br⁻, HOO⁻, O₂²⁻, O²⁻, R₁₇COO⁻, R₁₇O⁻, LMeO⁻ or LMeOO⁻, wherein R₁₇ is hydrogen or unsubstituted or substituted C₁-C₁₈alkyl or aryl, and
L and Me are as defined in claim 1.

4. A method according claim 1, wherein
Y is R₁₇COO⁻, ClO₄⁻, BF₄⁻, PF₆⁻, R₁₇SO₃⁻, R₁₇SO₄⁻, SO₄²⁻, NO₃⁻, F⁻, Cl⁻, Br⁻ or I⁻, wherein
R₁₇ is hydrogen or unsubstituted or substituted C₁-C₁₈alkyl or aryl.

5. A method according to claim 1, wherein
n is an integer having a value of from 1 to 4.

6. A method according to claim 1, wherein
m is an integer having a value of 1 or 2.

7. A method according to claim 1, wherein
p is an integer having a value of from 0 to 4.

8. A method according to claim 1, wherein
z is an integer having a value of from 8− to 8+.

9. A method according to claim 1, wherein
R₅ is C₁-C₁₂alkyl; phenyl unsubstituted or substituted by C₁-C₄alkyl, C₁-C₄alkoxy, halogen, cyano, nitro, carboxy, sulfo, hydroxy, amino, N-mono- or N,N-di-C₁-C₄alkylamino unsubstituted or substituted by hydroxy in the alkyl moiety, N-phenylamino,
N-naphthylamino, phenyl, phenoxy or by naphthyloxy; cyano; halogen; nitro; —COOR₁₂ or —SO₃R₁₂
wherein R₁₂ is in each case hydrogen, a cation, C₁-C₁₂alkyl, unsubstituted phenyl or phenyl substituted as indicated above; —SR₁₃, —SO₂R₁₃ or —OR₁₃
wherein R₁₃ is in each case hydrogen, C₁-C₁₂alkyl, unsubstituted phenyl or phenyl substituted as indicated above;
—N(R₁₃)—NR₁₄R₁₅
wherein R₁₃ is as defined above and R₁₄ and R₁₅ are each independently of the other hydrogen, unsubstituted or hydroxy-substituted C₁-C₁₂alkyl, unsubstituted phenyl or phenyl substituted as indicated above,
or R₁₄ and R₁₅, together with the nitrogen atom linking them, form an unsubstituted or C₁-C₄alkyl-substituted pyrrolidine, piperidine, piperazine, morpholine or azepane ring;
—NR₁₄R₁₅ or —N^{⊕}R₁₄R₁₅R₁₆ wherein R₁₄, R₁₅ and R₁₆ are each independently of the other(s) hydrogen, unsubstituted or hydroxy-substituted C₁-C₁₂alkyl, unsubstituted phenyl or phenyl substituted as indicated above,
or R₁₄ and R₁₅, together with the nitrogen atom linking them, form an unsubstituted or C₁-C₄alkyl-substituted pyrrolidine, piperidine, piperazine, morpholine or azepane ring; N-mono- or N,N-di-C₁-C₄alkyl-N^{⊕}R₁₄R₁₅R₁₆ unsubstituted or substituted by hydroxy in the alkyl moiety,
wherein R₁₄, R₁₅ and R₁₆ are each independently of the others hydrogen, unsubstituted or hydroxy-substituted C₁-C₁₂alkyl, unsubstituted phenyl or phenyl substituted as indicated above, or R₁₄ and R₁₅, together with the nitrogen atom linking them, form a pyrrolidine, piperidine, piperazine, morpholine or azepane ring which is unsubstituted or substituted by at least one C₁-C₄alkyl or by at least one unsubstituted C₁-C₄alkoy and/or substituted C₁-C₄alkyl, wherein the nitrogen atom may be quaternised; N-mono- or N,N-di-C₁-C₄alkyl-NR₁₄R₁₅ unsubstituted or substituted by hydroxy in the alkyl moiety, wherein R₁₄ and R₁₅ may have any one of the above meanings.

10. A methods according to claim 1, wherein L have the following formula (3) 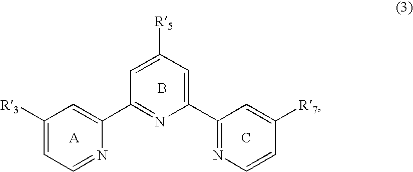
wherein
R′₃ and R′₇ are independently from each other hydrogen; C₁-C₄alkoxy; hydroxy; N-mono- or N,N-di-C₁-C₄alkylamino unsubstituted or substituted by hydroxy in the alkyl moiety, wherein the nitrogen atoms, especially the nitrogen atoms that are not bonded to one of the rings A, B and/or C, may be quaternised; or a pyrrolidine, piperidine, piperazine, morpholine or azepane ring unsubstituted or substituted by at least one C₁-C₄alkyl, wherein the amino groups may be quaternised,
R′₅ is C₁-C₄alkoxy; hydroxy; N-mono- or N,N-di-C₁-C₄alkylamino unsubstituted or substituted by hydroxy in the alkyl moiety, wherein the nitrogen atoms, especially the nitrogen atoms that are not bonded to one of the rings A, B and/or C, may be quaternised; or a pyrrolidine, piperidine, piperazine, morpholine or azepane ring unsubstituted or substituted by at least one C₁-C₄alkyl, wherein the amino groups may be quaternised.

11. A methods according to claim 10, wherein L have the following formula (3) 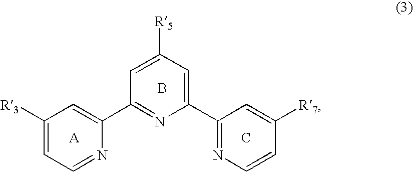
wherein
R′₃ and R′₇ are independently from each other hydrogen; C₁-C₄alkoxy; hydroxy; N-mono- or N,N-di-C₁-C₄alkylamino unsubstituted or substituted by hydroxy in the alkyl moiety, wherein the nitrogen atoms, especially the nitrogen atoms that are not bonded to one of the rings A, B and/or C, may be quaternised; or a pyrrolidine, piperidine, piperazine, morpholine or azepane ring unsubstituted or substituted by at least one C₁-C₄alkyl, wherein the amino groups may be quaternised,
R′₅ is C₁-C₄alkoxy; hydroxy; N-mono- or N,N-di-C₁-C₄alkylamino unsubstituted or substituted by hydroxy in the alkyl moiety, wherein the nitrogen atoms, especially the nitrogen atoms that are not bonded to one of the rings A, B and/or C, may be quaternised; or a pyrrolidine, piperidine, piperazine, morpholine or azepane ring unsubstituted or substituted by at least one C₁-C₄alkyl, wherein the amino groups may be quaternised,
with the proviso that
(i) at least one of the substituents R′₃, R′₅ and R′₇ is one of the radicals 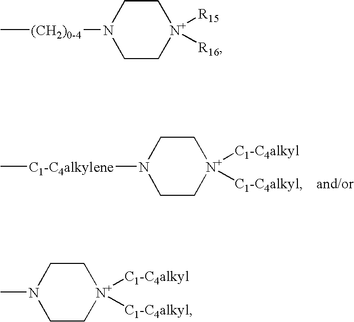
wherein R₁₅ and R₁₆ are independently from each other hydrogen or unsubstituted or substituted C₁-C₁₈alkyl or unsubstituted or substituted aryl and
wherein the unbranched or branched alkylene group may be unsubstituted or substituted, and wherein the C₁-C₄alkyl groups, which are branched or unbranched independently of one another, may be unsubstituted or substituted and wherein the piperazine ring may be unsubstituted or substituted.

12. A methods according to claim 1, wherein L have the following formula (4) and/or (5) 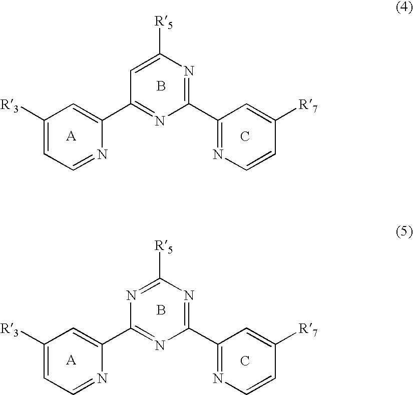
wherein
R′₅ is C₁-C₄alkoxy; Cl; hydroxy; phenyl; phenyl substituted by OC₁-C₂alkyl, OH or C₁-C₄alkyl; N-mono- or N,N-di-C₁-C₄alkylamino unsubstituted or substituted by hydroxy in the alkyl moiety; or —NR₁₄R₁₅; —(C₁-C₆alkylene)-NR₁₄R₁₅;
—N(R₁₃)—(C₁-C₆alkylene)-NR₁₄R₁₅; —N[(C₁-C₆alkylene)-NR₁₄R₁₅]₂; or —N(R₁₃)—N—R₁₄R₁₅, wherein
R₁₃ is hydrogen; C₁-C₁₂alkyl or unsubstituted phenyl or phenyl substituted by (substituted in the alkyl moiety by hydroxy) N-mono- or
N,N-di-C₁-C₄alkylamino-, N-phenylamino-, N-naphthylamino-, phenyl-, phenoxy- or naphthyloxy, and
R₁₄ and R₁₅ are each independently of the other hydrogen, unsubstituted or hydroxy-substituted C₁-C₁₂alkyl, unsubstituted phenyl or phenyl substituted as indicated above, or
R₁₄ and R₁₅, together with the nitrogen atom linking them, form a pyrrolidine, piperidine, piperazine, morpholine or azepane ring that is unsubstituted or substituted by at least one unsubstituted C₁-C₄alkyl and/or substituted C₁-C₄alkyl, especially a pyrrolidine, piperidine, piperazine, morpholine or azepane ring, and
R′₃ and R′₇ are each independently of the other hydrogen; C₁-C₄alkoxy; Cl; hydroxy; phenyl; phenyl substituted by OC₁-C₂alkyl, OH or C₁-C₄alkyl; N-mono- or N,N-di-C₁-C₄alkylamino substituted by hydroxy in the alkyl moiety; or —NR₁₄R₁₅; —(C₁-C₆alkylene)-NR₁₄R₁₅, —N(R₁₃)—(C₁-C₆alkylene)-NR₁₄R₁₅; —N[(C₁-C₆alkylene)-NR₁₄R₁₅]₂; or —N(R₁₃)—N—R₁₄R₁₅, wherein
R₁₃ is hydrogen; C₁-C₁₂alkyl or unsubstituted phenyl or phenyl substituted by (substituted in the alkyl moiety by hydroxy) N-mono- or N,N-di-C₁-C₄alkylamino-, N-phenylamino-, N-naphthylamino-, phenyl-, phenoxy- or naphthyloxy, and
R₁₄ and R₁₅ are each independently of the other hydrogen; unsubstituted or hydroxy-substituted C₁-C₁₂alkyl, unsubstituted phenyl or phenyl substituted as indicated above, or
R₁₄ and R₁₅, together with the nitrogen atom linking them, form a pyrrolidine, piperidine, piperazine, morpholine or azepane ring that is unsubstituted or substituted by at least one unsubstituted C₁-C₄alkyl and/or substituted C₁-C₄alkyl, especially a pyrrolidine, piperidine, piperazine, morpholine or azepane ring.

13. A method according to claim 12, wherein L have the following formula (4) and/or (5) 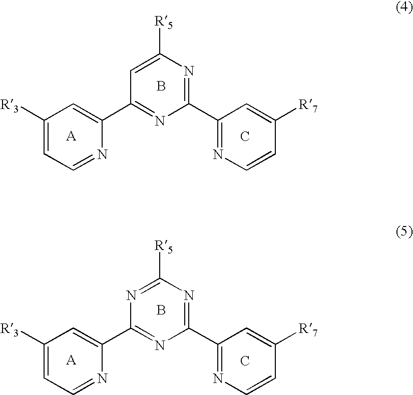
wherein R′₃ and R′₇ are independently from each other hydrogen; C₁-C₄alkoxy; Cl; hydroxy; phenyl; phenyl substituted by OC₁-C₂alkyl, OH or C₁-C₄alkyl; N-mono- or N,N-di-C₁-C₄alkylamino unsubstituted or substituted by hydroxy in the alkyl moiety, wherein the nitrogen atoms, especially the nitrogen atoms that are not bonded to one of the rings A, B and/or C, may be quaternised; or a pyrrolidine, piperidine, piperazine, morpholine or azepane ring unsubstituted or substituted by at least one C₁-C₄alkyl, wherein the amino groups may be quaternised,
R′₅ is C₁-C₄alkoxy; Cl; hydroxy; phenyl; phenyl substituted by OC₁-C₂alkyl, OH or C₁-C₄alkyl; N-mono- or N,N-di-C₁-C₄alkylamino unsubstituted or substituted by hydroxy in the alkyl moiety, wherein the nitrogen atoms, especially the nitrogen atoms that are not bonded to one of the rings A, B and/or C, may be quaternised; or a pyrrolidine, piperidine, piperazine, morpholine or azepane ring unsubstituted or substituted by at least one C₁-C₄alkyl, wherein the amino groups may be quaternised,
with the proviso that
(i) at least one of the substituents R₁₃, R₁₅ and R₁₇ is one of the radicals 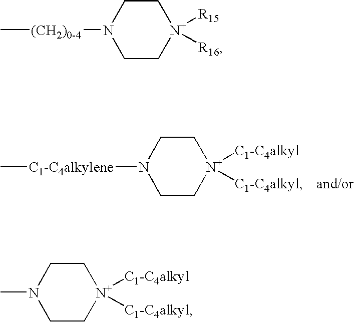
wherein R₁₅ and R₁₆ are independently from each other hydrogen or unsubstituted or substituted C₁-C₁₈alkyl or unsubstituted or substituted aryl and
wherein the unbranched or branched alkylene group may be unsubstituted or substituted, and wherein the C₁-C₄alkyl groups, which are branched or unbranched independently of one another, may be unsubstituted or substituted and wherein the piperazine ring may be unsubstituted or substituted.

14. A methods according to claim 1 wherein at least one mono- or poly-peroxy acid having at least 1 to 20 carbon atoms in the alkyl chain and/or its corresponding precursor and H₂O₂ is used.

15. A method according to claim 14 wherein at least one
organic peroxy acids of formula 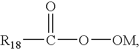
wherein
M signifies hydrogen or a cation,
R₁₈ signifies unsubstituted C₁-C₁₈alkyl; substituted C₁-C₁₈alkyl; unsubstituted aryl; substituted aryl; —(C₁-C₆alkylene)-aryl, wherein the alkylene and/or the Palo group may be substituted; and
phthalimidoC₁-C₈alkylene, wherein the phthalimido and/or the alkylene group may be substituted is used.

16. A method according to claim 15,
wherein CH₃COOOH or epsilon-phthalimido peroxy hexanoic acid or a alkali salt thereof is used.

17. A method according to claim 1,
wherein TAED and/or NOBS as precursors of peroxy acids and sodium percarbonate and/or sodium perborate are used.

18. A method according to claim 1 for the bleaching of stains, bleaching of soiling on textile material, for the prevention of redeposition of migrating dyes, or for the cleaning of hard surfaces.

19. A method according to claim 1, wherein the metal complex compounds of formula (1) are used as catalysts for reactions using peroxo acids or their precursors for bleaching in the context of paper making.

20. A method according to claim 1, wherein the metal complex compounds of formula (1) are used in detergent, cleaning, disinfecting or bleaching compositions.

21. A method according to claim 1, wherein the metal complex compounds of formula (1) are used in automatic dishwasher formulations.

22. A method according to claim 20, wherein the metal complex compounds of formula (1) are formed in situ in the detergent, cleaning, disinfecting or bleaching composition.

23. A detergent, cleaning, disinfecting or bleaching composition containing
I) from 0 to 50 wt-%, A) of at least one anionic surfactant and/or B) of a non-ionic surfactant,
II) from 0 to 70 wt-%, C) of at least one builder substance,
III) 1-99 wt-%, D) of at least one peroxy acid and/or at least one precursors of peroxy acid, the latter in combination with hydrogen peroxide and/or a precursor of hydrogen peroxide.
IV) E) at least one metal complex compound of formula (1) as defined in claim 1 in an amount that, in the liquor, gives a concentration of from 0.5 to 100 mg/litre of liquor, when from 0.5 to 20 g/litre of the detergent, cleaning, disinfecting or bleaching agent are added to the liquor, and
V) water ad 100 wt-%,
wherein the percentages are in each case percentages by weight, based on the total weight of the composition.

24. A solid formulation containing
a) from 1 to 99 wt-%, of at least one metal complex compound of formula (1) as defined in claim 1 and at least one organic peroxy acid and/or at least one precursor of an organic peroxy acid and H₂O₂.
b) from 1 to 99 wt-%, of at least one binder,
c) from 0 to 20 wt-%, of at least one encapsulating material,
d) from 0 to 20 wt-% of at least one further additive and
e) from 0 to 20 wt-% water.

25. A solid formulation according to claim 24, which is in the form of granules.
